(19) United States
(12) Patent Application Publication
(10) Pub. No.: US 2026/0025869 A1
(43) Pub. Date: Jan. 22, 2026

(54) DYNAMIC COEXISTENCE PROCEDURES FOR ELECTRONIC DEVICES

(71) Applicant: Apple Inc., Cupertino, CA (US)

(72) Inventors: Arun Vijayakumari MAHASENAN, Fremont, CA (US); Venkateswara Rao MANEPALLI, San Jose, CA (US); KoChien C. LEE, San Jose, CA (US); Stephanus G. HEGGE, Dusseldorf (DE); Ishwarappa JAKKALI, San Jose, CA (US); Karthik THYAGARAJAN, Los Gatos, CA (US)

(21) Appl. No.: 19/186,528

(22) Filed: Apr. 22, 2025

Related U.S. Application Data
(60) Provisional application No. 63/674,240, filed on Jul. 22, 2024.
(60) Provisional application No. 63/674,242, filed on Jul. 22, 2024.

(51) Int. Cl. H04W 76/15

(52) U.S. Cl. CPC H04W 76/15

(57) ABSTRACT

The subject technology provides for dynamic coexistence procedures. An apparatus may apply one or more coexistence procedures associated with a first wireless communication protocol based on a coexistence between activity associated with the first wireless communication protocol and activity associated with a second wireless communication protocol different than the first wireless communication protocol on a shared frequency band. The apparatus also may monitor for reception of a data transmission associated with the first wireless communication protocol on the shared frequency band based at least in part on the one or more coexistence procedures. By applying these dynamic coexistence procedures, the reliability of transmissions in a mesh network is increased and coexistence between radios sharing the same frequency band can be improved.

### CROSS-REFERENCE TO RELATED APPLICATION(S)

This application claims the benefit of U.S. Provisional Application Ser. No. 63/674,240, entitled “DYNAMIC COEXISTENCE PROCEDURES FOR ELECTRONIC DEVICES,” and filed on Jul. 22, 2024, and U.S. Provisional Application Ser. No. 63/674,242, entitled “DYNAMIC COEXISTENCE PROCEDURES FOR ELECTRONIC DEVICES,” and filed on Jul. 22, 2024, the disclosures of which are expressly incorporated by reference herein in their entirety.

### TECHNICAL FIELD

The present description generally relates to wireless communication systems and, in particular to, dynamic coexistence procedures for device-to-device wireless communications.

### BACKGROUND

A mesh network may include router devices to forward packets between end devices of the network. That is, the end devices communicate with a corresponding router of the network but may not forward packets for other network devices. In this way, the router may act as a parent device for the end devices. End devices wake and poll their parent device.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment in accordance with one or more implementations.

FIG. 2 conceptually illustrates an example of a system for performing signaling between an end device and a router in a mesh network in accordance with one or more implementations.

FIG. 3 is a schematic diagram illustrating example dynamic coexistence procedures between an end device and a router in accordance with one or more implementations.

FIG. 4 is a schematic diagram of an example closed-loop audio feedback mechanism in accordance with one or more implementations.

FIG. 5 is a flow chart of an example process that may be performed by processing circuitry of an end device for dynamic coexistence procedures in accordance with one or more implementations.

FIG. 6 conceptually illustrates an example of a resource grid with an example dynamic coexistence procedure in accordance with one or more implementations.

FIG. 7 is a schematic diagram illustrating an example dynamic coexistence procedure between an end device and a sleepy router in accordance with one or more implementations.

FIG. 8 is a flow chart of an example process that may be performed by processing circuitry of a sleepy router device for dynamic coexistence procedures in accordance with one or more implementations.

FIG. 9 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

The present disclosure relates to enabling communication between end devices of a network. In some cases, communication may be enabled via a temporary connection (e.g., on an on-demand and/or as-needed basis). Specifically, the network may include a mesh network and the communication between devices may be in accordance with the mesh network communication protocol. For example, the mesh network communication protocol may utilize a router to forward packets between end devices of the mesh network. That is, the router may act as a parent device for the end devices. The parent device may provide connectivity and manage communication with the end devices. As such, an end device may utilize a radio to transmit a message to another end device, e.g., over the mesh network, via the router. In other examples, end devices may communicate with each other over the mesh network without a router. In one example, the router may forward information between the mesh network and a non-mesh network, such as a Wi-Fi network. In that case, the router may be referred to as a “border router” and convert a Wi-Fi message to the mesh network communication protocol and transmit the converted mesh network message to the target end device using a mesh network radio.

In one or more implementations, the end devices may be sleepy end devices (SEDs), which are normally disabled (e.g., asleep) and wake on occasion to poll for messages from a parent device (e.g., the router). In this regard, SEDs can include battery-powered accessories that exhibit intermittent radio functionality due to resource or battery constraints. In one or more implementations, an SED may awaken when a “wakeup message” is received. For example, the router may transmit the wakeup message to the SED. The wakeup message may instruct the SED to wake-up to poll for messages at a time different than a schedule polling period. In one or more implementations, the end devices may continue to operate as SE Ds and use coordinated sampled listening (CSL) techniques to communicate (e.g., via the mesh network communication protocol).

When an electronic device, such as a phone, integrates into a mesh network, the electronic device may function as a SED because of its multiple radios, including Bluetooth, Wi-Fi, and mesh network radios, operating in a designated frequency spectrum (e.g., 2.4 gigahertz (GHz) band or the like). Concurrent operation of these radios introduces challenges due to coexistence constraints. In one or more implementations, coexistence refers to the ability of multiple wireless communication systems to operate in the same frequency bands without causing significant interference to each other. The IEEE 802.15.4 standard addresses these challenges by introducing SEDs and defining data poll procedures for receiving incoming data. During data polling, the SED periodically enters sleep state to conserve power and awakens to query its leader (or parent device) for data. If data is available, the parent device buffers the data until the SED retrieves it, necessitating the SED to activate its receiver for a specified duration. However, continuous reception presents challenges related to power consumption in coexistence-constrained devices such as SEDs.

In one or more other implementations, the electronic device may function as a sleepy router that employs CSL techniques to manage its low-power state and periodic wake-up schedule. In its low-power operation mode, the sleepy router can periodically wake up at pre-determined intervals (or referred to as CSL periods herein) to check for any incoming data transmissions from other devices in the mesh network. During these wake-up periods, the electronic device as a sleepy router may listen for data packets that may require forwarding or processing to end devices. This technique can allow the sleepy router to conserve energy by remaining in a low-power sleep state for most of the time and only becoming active during brief listening windows (or CSL periods).

Embodiments of the subject technology provide for dynamic coexistence procedures. An apparatus may apply one or more dynamic coexistence procedures associated with a first wireless communication protocol. The apparatus also may monitor for reception of a data transmission associated with the first wireless communication protocol based at least in part on the one or more dynamic coexistence procedures. By applying these dynamic coexistence procedures, the reliability of transmissions in a mesh network is increased and coexistence between radios sharing the same frequency band can be improved.

In one or more implementations, the dynamic coexistence procedures include scheduling an outgoing data poll message that is aligned with coexistence activity in a data poll procedure between a parent device and a child device, improving coexistence between radios sharing the same frequency band and reducing packet loss occurrences compared to misaligned data poll messaging. In one or more other implementations, the dynamic coexistence procedures also include adjusting a priority of mesh network traffic over Bluetooth traffic when mesh network data is available to be transmitted between parent and child devices. In one or more other implementations, the dynamic coexistence procedures also include monitoring a quality metric of Bluetooth traffic and adjusting the mesh network traffic to minimize interference onto the Bluetooth traffic, improving coexistence between the radios sharing the same frequency band. For example, adjusting the mesh network traffic may include adjusting a periodicity of the outgoing data poll message based on the quality metric. In one or more other implementations, the dynamic coexistence procedures also include dynamically adjusting a CSL period to increase the rate of mesh network traffic when Bluetooth traffic is not active, improving the performance of wireless communication protocols in coexistence. Dynamic coexistence procedures facilitate the optimization of efficient data retrieval while minimizing power consumption within a mesh network, improving overall system performance.

In one or more other implementations, an apparatus may receive, from an end device in a mesh network, a data poll message requesting a data transmission associated with a first wireless communication protocol based on one or more coexistence procedures applied to a resource allocation associated with the first wireless communication protocol based on a coexistence between activity associated with the first wireless communication protocol and activity associated with a second wireless communication protocol different than the first wireless communication protocol on a shared frequency band. The apparatus also may provide an acknowledgement message for transmission to the end device, in which the acknowledgment message indicates whether data is available for transmission to the end device. The apparatus also may facilitate a data transmission associated with the first wireless communication protocol with the end device on the shared frequency band based on the acknowledgment message indicating that data is available for transmission to the end device.

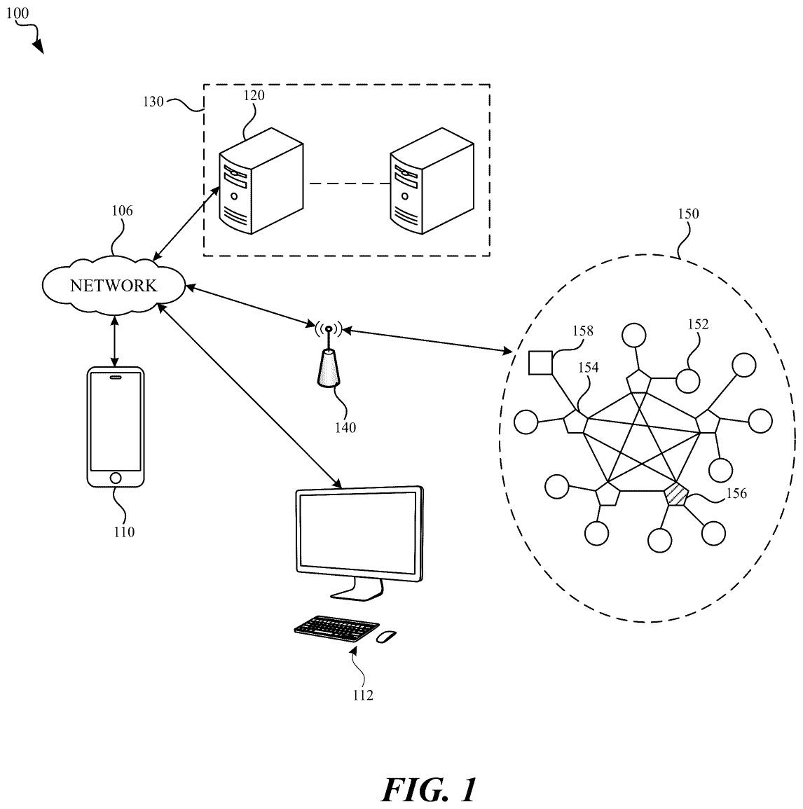

FIG. 1 illustrates an example network environment 100 in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The following description is provided for the network environment 100 that operates in conjunction with the IEEE 802.15.4 standards for low-rate wireless personal area networks (LR-WPANs). It should be understood that the concepts disclosed herein may also be applied to other networks, including Thread®, Zigbee®, Z-Wave®, Bluetooth Low Energy (BLE), ISA100.11a, WirelessHART®, MiWi™, IPV6 over Low-Power Wireless Personal Area Networks (6L oW PAN), Subnetwork Access Protocol (SNAP), Wi-Fi mesh networks, and the like.

The network environment 100 includes an electronic device 110, an electronic device 112, a server 120, an access point 140 and a mesh network 150. The network 106 may communicatively (directly or indirectly) couple the electronic device 110 and/or the server 120. In one or more implementations, the network 106 may be an interconnected network of devices that may include, or may be communicatively coupled to, the Internet. For explanatory purposes, the network environment 100 is illustrated in FIG. 1 as including the electronic device 110, the electronic device 112, and the server 120; however, the network environment 100 may include any number of electronic devices and any number of servers or a data center including multiple servers.

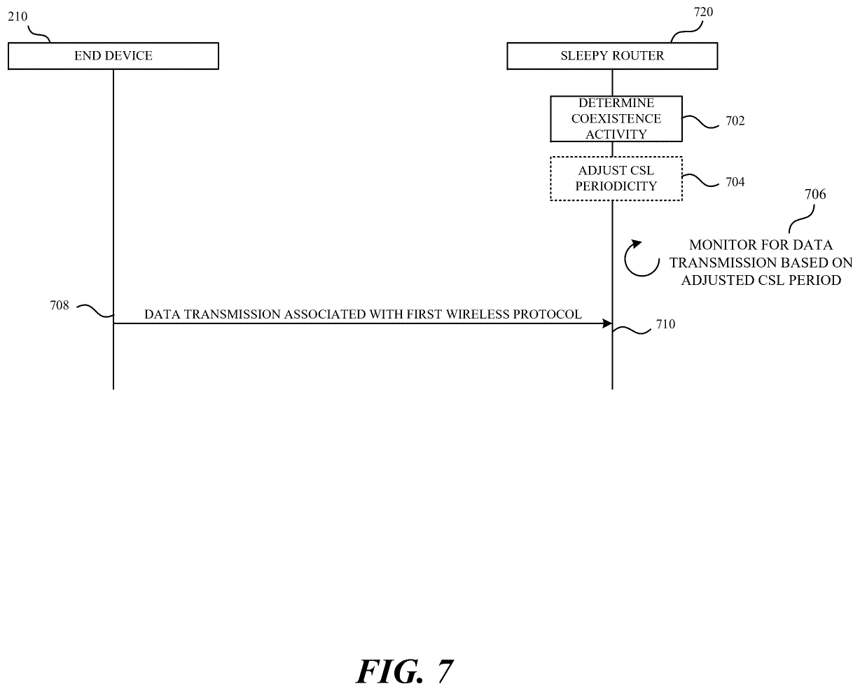

The electronic device 110 may be, for example, a desktop computer, a portable computing device such as a laptop computer, a smartphone, a peripheral device (e.g., a digital camera, headphones), a tablet device, a wearable device such as a watch, a band, and the like. In FIG. 1, by way of example, the electronic device 110 is depicted as a mobile electronic device (e.g., smartphone). The electronic device 110 may be, and/or may include all or part of, the electronic system discussed below with respect to FIG. 7.

The electronic device 112 may be, for example, desktop computer, a portable computing device such as a laptop computer, a smartphone, a peripheral device (e.g., a digital camera, headphones), a tablet device, a wearable device such as a watch, a band, and the like. In FIG. 1, by way of example, the electronic device 112 is depicted as a desktop computer. The electronic device 112 may be, and/or may include all or part of, the electronic system discussed below with respect to FIG. 7.

The server 120 may form all or part of a network of computers or a group of servers 130, such as in a cloud computing or data center implementation. For example, the server 120 stores data and software, and includes specific hardware (e.g., processors, graphics processors and other specialized or custom processors) for rendering and generating content such as graphics, images, video, audio and multi-media files. In an implementation, the server 120 may function as a cloud storage server that stores any of the aforementioned content generated by the above-discussed devices and/or the server 120.

In the example of FIG. 1, the electronic device 110 is depicted as a smartphone. However, it is appreciated that the electronic device 110 may be implemented as another type of device, such as a wearable device (e.g., a smart watch or other wearable device). The electronic device 110 may be a device of a user (e.g., the electronic device 110 may be associated with and/or logged into a user account for the user at a server). Although a single electronic device 110 is shown in FIG. 1, it is appreciated that the network environment 100 may include more than one electronic device, including more than one electronic device of a user and/or one or more other electronic devices of one or more other users.

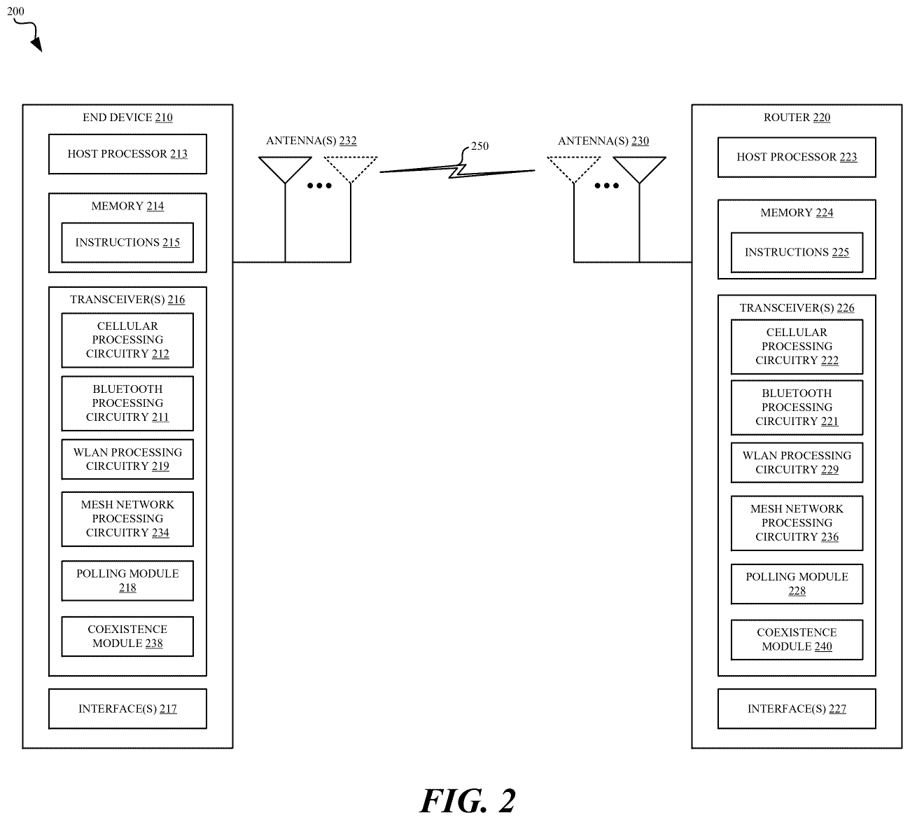

The mesh network 150 includes various end devices 152 and routers 154 (each of which may include any one of the electronic devices 110-112 of FIG. 1). In one or more implementations, the routers 154 (represented as pentagons) may forward packets (e.g., data) between and/or to the end devices 152 (represented as circles) of the mesh network 150. A router 154 may transmit a packet via a radio or transceiver, such as the transceiver 226 of FIG. 2, to a targeted end device 152 via another router 154. The routers 154 may also provide secure commissioning services for other devices attempting to join the mesh network 150. The transceiver 226 of each router 154 may be enabled at times for a specified duration to receive and transmit packets.

If a router 154 does not have any child devices (e.g., communicatively coupled end devices 152), the router 154 may be downgraded and/or configured to operate as an end device 152. Conversely, if a new end device attempting to join the mesh network 150 is within range of a current end device 152 of the mesh network 150 (but not a router 154), and that end device 152 is eligible to become a router 154, the end device 152 may be upgraded and/or configured to operate as a router 154 for the new end device. In that case, the new router 154 acts as a router 154 with respect to the new end device and is coupled to one or more other routers 154 of the mesh network 150.

Each end device 152 of the mesh network 150 may communicate primarily with a single router 154. For example, the end devices 152 may not forward packets for other network devices (e.g., end devices 152 and router 154). In one or more implementations, the end devices 152 are SEDs and may disable their respective transceivers (e.g., in the form of the transceiver 216 of FIG. 2) to reduce power consumption. In such cases, the end devices 152 serving as SEDs may wake on occasion to poll for messages from a corresponding router 154. An interval between polling for an end device 152 may be based on a schedule or other configuration of a corresponding transceiver (e.g., the transceiver 216 of FIG. 2), and may be controlled by a processor, such as the host processor 213 of FIG. 2, the mesh network processing circuitry 234 of FIG. 2, and/or a power management unit (PMU) of the end device 152.

Examples of end devices 152 and/or routers 154 include a cellular phone, a smart phone, a session initiation protocol phone, a laptop, a satellite radio, a global positioning system, a multimedia device, a video device, a digital audio player, a personal digital assistant, a camera, a game console, a tablet, a smart device, a wearable device, a vehicle, an electric meter, a gas pump, a kitchen appliance, a healthcare device, an implant, a sensor, an actuator, a display, or any other similar functioning device. Some of the end devices 152 and/or routers 154 may be referred to as Internet-of-Things (IoT) devices.

The mesh network 150 also includes a router 156 that serves as a leader node in the mesh network 150. In one or more implementations, the router 156 as the leader node can manage the overall network structure and operation of the mesh network 150, including initialization, synchronization, and topological control. The router 156 may act as a parent device for an end device 152 serving as a SED, buffering incoming data while the SED is in a sleep state. This procedure involves a downlink message to the SED, where the router 156 buffers the data until the SED awakens and queries for the data, known as the polling procedure. The SED then keeps its receiver (e.g., receiver portion of the transceiver 216 of FIG. 2) active for a specified duration to receive the incoming data. In one or more other implementations, the mesh network 150 also includes a border router 158 that may forward information between the mesh network 150 and a non-mesh network, such as the network 106, through the access point 140. The border router 158 can convert a Wi-Fi message to the mesh network communication protocol and transmit the converted mesh network message to a target end device (e.g., end device 152) using a mesh network radio . . .

Challenges arise when integrating with electronic devices such as smartphones, where radio resources are shared among various wireless technologies such as Wi-Fi and Bluetooth, posing coexistence constraints that can lead to interference with Bluetooth and Wi-Fi activities. The subject technology addresses this challenge with dynamic coexistence procedures, which optimize data reception by applying different techniques (e.g., adjusting periodicity of the data poll message, adjusting priorities, monitoring quality metrics, aligning data poll messages, adjusting CSL periodicity) when data is available for reception and/or other shared radio activities are inactive, improving coexistence and reducing the power consumption of the end device 152. This approach enhances mesh network communication technologies, offering improved performance and efficiency in coexistence-constrained environments.

FIG. 2 conceptually illustrates an example of a system 200 for performing signaling between an end device and a router in a mesh network in accordance with one or more implementations. The system 200 may be a portion of the network environment 100. The end device 210 may be, for example, one of the electronic devices 110 of the network environment 100. The router 220 may be, for example, one of the electronic devices 110 of the network environment 100.

The end device 210 may include a host processor 213. The host processor 213 may execute instructions such that various operations of the end device 210 are performed. For example, the host processor 213 can serve as the CPU responsible for executing instructions and managing various tasks. The host processor 213 can include multiple cores, each capable of handling multiple threads simultaneously, enabling multitasking. The host processor 213 can integrate various components such as arithmetic logic units (ALUs), registers, cache memory, and control units to execute instructions and process data. Additionally, the host processor 213 can include integrated DSPs, graphics processing units (GPUs), neural processing units (NPUs), and hardware accelerators for enhanced performance in tasks such as multimedia processing, artificial intelligence (AI), and gaming. The host processor 213 may be implemented using, for example, an ASIC, a controller, a FPGA device, another hardware device, a firmware device, or any combination thereof configured to perform the operations described herein.

The end device 210 may include one or more transceiver(s) 216 that may include radio frequency (RF) transmitter and/or receiver circuitry that use the antenna(s) 232 of the end device 210 to facilitate signaling (e.g., the signaling 250) to and/or from the end device 210 with other devices (e.g., the router 220) according to corresponding wireless communication protocols (e.g., cellular, Wi-Fi, Bluetooth). The one or more transceivers 216 can be responsible for both transmitting and receiving radio signals. The one or more transceivers 216 can facilitate wireless communication by converting digital data into radio waves for transmission and then converting received radio waves back into digital data for the end device 210 to process. The one or more transceivers 216 can operate within specific frequency bands allocated for wireless communication and may employ various modulation techniques to optimize data transmission efficiency and reliability. In one or more implementations, the one or more transceiver(s) 216 are not limited to specific wireless communication protocols, including Bluetooth, Thread®, Wi-Fi, cellular, among others, as it is appreciated that other wireless communication protocols and/or technologies can be associated with the one or more transceiver(s) 216.

The end device 210 may include a memory 214. The memory 214 may be a non-transitory computer-readable storage medium that stores instructions 215 (which may include, for example, the instructions being executed by one or more components in the transceiver 216 and/or the host processor 213). The instructions 215 may also be referred to as program code or a computer program. The memory 224 may also store data used by, and results computed by, the transceiver 216 and/or the host processor 213.

The end device 210 may include cellular processing circuitry 212. The cellular processing circuitry 212 is responsible for handling communication tasks related to the transmission and reception of wireless signals. The cellular processing circuitry 212 is specialized for managing the modulation, demodulation, encoding, decoding, and other signal processing tasks necessary for cellular communication. The cellular processing circuitry 212 can interface with the RF components and antenna(s) (e.g., the one or more antennas 232) to transmit and receive data, voice, and other multimedia content over wireless networks such as Global System for Mobile Communications (GSM), CDMA, LTE, and 5G. The cellular processing circuitry 212 also manages power control, signal quality monitoring, and handover procedures to ensure reliable and efficient communication. The cellular processing circuitry 212 may execute instructions such that various operations of the end device 210 are performed, as described herein. The cellular processing circuitry 212 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

In one or more implementations, the one or more transceivers 216 can operate in conjunction with the cellular processing circuitry 212 to facilitate cellular communication. The one or more transceivers 216 is responsible for converting digital data from the cellular processing circuitry 212 into radio signals for transmission over the air and for receiving incoming radio signals, which are then converted back into digital data for processing by the cellular processing circuitry 212. This collaboration enables the end device 210 to transmit and receive data, supporting functions such as voice calls, text messaging, internet access, and other wireless services. The cellular processing circuitry 212 manages the digital signal processing tasks, while the one or more transceivers 216 handle the analog RF operations, working together to enable wireless communication capabilities in the end device 210.

The end device 210 may include Bluetooth processing circuitry 211. The Bluetooth processing circuitry 211 is responsible for managing the transmission and reception of wireless signals to and from mobile devices (e.g., end device 210) for Bluetooth communication. The Bluetooth processing circuitry 211 can perform various signal processing tasks related to modulation, demodulation, encoding, decoding, and error correction to ensure reliable communication over the air interface. The Bluetooth processing circuitry 211 may execute instructions such that various operations of the end device 210 are performed, as described herein. The Bluetooth processing circuitry 211 may include one or more baseband processors implemented using, for example, a CPU, a DSP, an ASIC, a controller, an FPGA device, another hardware device, a firmware device, or any combination thereof configured to perform the operations described herein.

In one or more implementations, the one or more transceivers 216 can operate in conjunction with the Bluetooth processing circuitry 211 to facilitate Bluetooth communication. The one or more transceivers 216 is responsible for converting digital data from the Bluetooth processing circuitry 211 into radio signals for transmission over the air and for receiving incoming radio signals, which are then converted back into digital data for processing by the Bluetooth processing circuitry 211. This collaboration enables the end device 210 to transmit and receive data, supporting functions such as audio services, Internet access, and other wireless services via Bluetooth. The Bluetooth processing circuitry 211 manages the digital signal processing tasks, while the one or more transceivers 216 handle the analog RF operations, working together to enable wireless communication capabilities in the end device 210.

The end device 210 may include WLAN processing circuitry 219. The WLAN processing circuitry 219 is responsible for managing the transmission and reception of wireless signals to and from mobile devices (e.g., end device 210) for Wi-Fi communication. The WLAN processing circuitry 219 can perform various signal processing tasks related to modulation, demodulation, encoding, decoding, and error correction to ensure reliable communication over the air interface. The WLAN processing circuitry 219 may execute instructions such that various operations of the end device 210 are performed, as described herein. The WLAN processing circuitry 219 may include one or more baseband processors implemented using, for example, a CPU, a DSP, an ASIC, a controller, an FPGA device, another hardware device, a firmware device, or any combination thereof configured to perform the operations described herein.

In one or more implementations, the one or more transceivers 216 can operate in conjunction with the WLAN processing circuitry 219 to facilitate Wi-Fi communication. The one or more transceivers 216 is responsible for converting digital data from the WLAN processing circuitry 219 into radio signals for transmission over the air and for receiving incoming radio signals, which are then converted back into digital data for processing by the WLAN processing circuitry 219. This collaboration enables the end device 210 to transmit and receive data, supporting functions such as voice calls, text messaging, Internet access, and other wireless services via Wi-Fi. The WLAN processing circuitry 219 manages the digital signal processing tasks, while the one or more transceivers 216 handle the analog RF operations, working together to enable wireless communication capabilities in the end device 210.

The end device 210 may include mesh network processing circuitry 234. The mesh network processing circuitry 234 is responsible for managing the transmission and reception of wireless signals to and from mobile devices (e.g., end device 210) for mesh network communication. The mesh network processing circuitry 234 can perform various signal processing tasks related to modulation, demodulation, encoding, decoding, and error correction to ensure reliable communication over the air interface. The mesh network processing circuitry 234 may execute instructions such that various operations of the end device 210 are performed, as described herein. The mesh network processing circuitry 234 may include one or more baseband processors implemented using, for example, a CPU, a DSP, an ASIC, a controller, an FPGA device, another hardware device, a firmware device, or any combination thereof configured to perform the operations described herein.

In one or more implementations, the one or more transceivers 216 can operate in conjunction with the mesh network processing circuitry 234 to facilitate mesh network communication. The one or more transceivers 216 is responsible for converting digital data from the mesh network processing circuitry 234 into radio signals for transmission over the air and for receiving incoming radio signals, which are then converted back into digital data for processing by the mesh network processing circuitry 234. This collaboration enables the end device 210 to transmit and receive data, supporting functions such as voice calls, text messaging, Internet access, and other wireless services via the mesh network 150 of FIG. 1. The mesh network processing circuitry 234 manages the digital signal processing tasks, while the one or more transceivers 216 handle the analog RF operations, working together to enable wireless communication capabilities in the end device 210.

The end device 210 may include one or more antenna(s) 232 (e.g., one, two, four, or more). In implementations having multiple antenna(s) 230, the router 220 may perform multiple-in-multiple-out (MIMO), digital beamforming, analog beamforming, beam steering, etc. For implementations with multiple antenna(s) 232, the end device 210 may leverage the spatial diversity of such multiple antenna(s) 232 to send and/or receive multiple different data streams on the same time and frequency resources.

The end device 210 may include one or more interface(s) 217. The interface(s) 217 may be used to provide input to or output from the end device 210. For example, an end device 210 that is a UE may include interface(s) 217 such as microphones, speakers, a touchscreen, buttons, and the like to allow for input and/or output to the UE by a user of the UE. Other interfaces of such a UE may be made up of made up of transmitters, receivers, and other circuitry (e.g., other than the transceiver(s) 216/antenna(s) 232 already described) that allow for communication between the UE and other devices and may operate according to known protocols (e.g., Wi-Fi®, Bluetooth®, and the like).

The end device 210 may include polling module 218. The polling module 218 may be implemented via hardware, software, or combinations thereof. For example, the polling module 218 may be implemented as a processor, circuit, and/or instructions 215 stored in the memory 214 and executed by the host processor 213 and/or the transceiver 216. In some examples, the polling module 218 may be integrated within the transceiver(s) 216. For example, the polling module 218 may be implemented by a combination of software components (e.g., executed by a DSP or a general processor) and hardware components (e.g., logic gates and circuitry) within the transceiver(s) 216. In other examples, the polling module 218 is a separate component from the transceiver(s) 216.

The end device 210 may include coexistence module 238. The coexistence module 238 may be implemented via hardware, software, or combinations thereof. For example, the coexistence module 238 may be implemented as a processor, circuit, and/or instructions 215 stored in the memory 214 and executed by the host processor 213 and/or the transceiver 216. In some examples, the coexistence module 238 may be integrated within the transceiver(s) 216. For example, the coexistence module 238 may be implemented by a combination of software components (e.g., executed by a DSP or a general processor) and hardware components (e.g., logic gates and circuitry) within the transceiver(s) 216. In other examples, the coexistence module 238 is a separate component from the transceiver(s) 216.

The coexistence module 238 may be used for various aspects of the present disclosure, for example, aspects of FIG. 1 through FIG. 7. The coexistence module 238 is configured to, for example, apply one or more dynamic coexistence procedures associated with a first wireless communication protocol (e.g., mesh network). The coexistence module 238 is also configured to, for example, provide for transmission, to the router 220, the data poll message. The coexistence module 238 is also configured to, for example, using the mesh network processing circuitry 234, monitor for reception of a data transmission associated with the first wireless communication protocol based at least in part on the one or more dynamic coexistence procedures.

The router 220 may include a host processor 223. The host processor 223 may execute instructions such that various operations of the router 220 are performed. For example, the host processor 223 can serve as the central processing unit (CPU) responsible for executing instructions and managing various tasks. The host processor 223 can include multiple cores, each capable of handling multiple threads simultaneously, enabling multitasking. The host processor 223 can integrate various components such as AL Us, registers, cache memory, and control units to execute instructions and process data. Additionally, the host processor 223 can include integrated DSPs, GPUs, NPUs, and hardware accelerators. The host processor 223 may be implemented using, for example, an A SIC, a controller, a FPGA device, another hardware device, a firmware device, or any combination thereof configured to perform the operations described herein.

The router 220 may include one or more transceiver(s) 226 that may include RF transmitter and/or receiver circuitry that use the antenna(s) 230 of the router 220 to facilitate signaling (e.g., the signaling 250) to and/or from the router 220 with other devices (e.g., the end device 210) according to corresponding wireless communication protocols (e.g., cellular, Wi-Fi, Bluetooth). The one or more transceivers 226 can be responsible for both transmitting and receiving radio signals. The one or more transceivers 226 can facilitate wireless communication by converting digital data into radio waves for transmission and then converting received radio waves back into digital data for the router 220 to process. The one or more transceivers 226 can operate within specific frequency bands allocated for wireless communication and may employ various modulation techniques to optimize data transmission efficiency and reliability. In one or more implementations, the one or more transceiver(s) 226 are not limited to specific wireless communication protocols, including Bluetooth, Thread®, Wi-Fi, cellular, among others, as it is appreciated that other wireless communication protocols and/or technologies can be associated with the one or more transceiver(s) 226.

The router 220 may include a memory 224. The memory 224 may be a non-transitory computer-readable storage medium that stores instructions 225 (which may include, for example, the instructions being executed by one or more components in the transceiver 226 and/or the host processor 223). The instructions 225 may also be referred to as program code or a computer program. The memory 224 may also store data used by, and results computed by, the transceiver 226 and/or the host processor 223.

The router 220 may include cellular processing circuitry 222. The cellular processing circuitry 222 is responsible for managing the transmission and reception of wireless signals to and from mobile devices (e.g., end device 210). The cellular processing circuitry 222 can perform various signal processing tasks related to modulation, demodulation, encoding, decoding, and error correction to ensure reliable communication over the air interface. The cellular processing circuitry 222 may execute instructions such that various operations of the router 220 are performed, as described herein. The cellular processing circuitry 222 may include one or more baseband processors implemented using, for example, a CPU, a DSP, an ASIC, a controller, an FPGA device, another hardware device, a firmware device, or any combination thereof configured to perform the operations described herein.

In one or more implementations, the one or more transceivers 226 can operate in conjunction with the cellular processing circuitry 222 to facilitate cellular communication. The one or more transceivers 226 is responsible for converting digital data from the cellular processing circuitry 222 into radio signals for transmission over the air and for receiving incoming radio signals, which are then converted back into digital data for processing by the cellular processing circuitry 222. This collaboration enables the router 220 to transmit and receive data, supporting functions such as voice calls, text messaging, Internet access, and other wireless services via cellular. The cellular processing circuitry 222 manages the digital signal processing tasks, while the one or more transceivers 226 handle the analog RF operations, working together to enable wireless communication capabilities in the router 220.

The router 220 may include Bluetooth processing circuitry 221. The Bluetooth processing circuitry 221 is responsible for managing the transmission and reception of wireless signals to and from mobile devices (e.g., end device 210) for Bluetooth communication. The Bluetooth processing circuitry 221 can perform various signal processing tasks related to modulation, demodulation, encoding, decoding, and error correction to ensure reliable communication over the air interface. The Bluetooth processing circuitry 221 may execute instructions such that various operations of the router 220 are performed, as described herein. The Bluetooth processing circuitry 221 may include one or more processors implemented using, for example, a CPU, a DSP, an A SIC, a controller, an FPGA device, another hardware device, a firmware device, or any combination thereof configured to perform the operations described herein.

In one or more implementations, the one or more transceivers 226 can operate in conjunction with the Bluetooth processing circuitry 221 to facilitate Bluetooth communication. The one or more transceivers 226 is responsible for converting digital data from the Bluetooth processing circuitry 221 into radio signals for transmission over the air and for receiving incoming radio signals, which are then converted back into digital data for processing by the Bluetooth processing circuitry 221. This collaboration enables the router 220 to transmit and receive data, supporting functions such as audio services, Internet access, and other wireless services via Bluetooth. The Bluetooth processing circuitry 221 manages the digital signal processing tasks, while the one or more transceivers 226 handle the analog RF operations, working together to enable wireless communication capabilities in the router 220.

The router 220 may include WLAN processing circuitry 229. The WLAN processing circuitry 229 is responsible for managing the transmission and reception of wireless signals to and from mobile devices (e.g., end device 210) for Wi-Fi communication. The WLAN processing circuitry 229 can perform various signal processing tasks related to modulation, demodulation, encoding, decoding, and error correction to ensure reliable communication over the air interface. The WLAN processing circuitry 229 may execute instructions such that various operations of the router 220 are performed, as described herein. The WLAN processing circuitry 229 may include one or more processors implemented using, for example, a CPU, a DSP, an A SIC, a controller, an FPGA device, another hardware device, a firmware device, or any combination thereof configured to perform the operations described herein.

In one or more implementations, the one or more transceivers 226 can operate in conjunction with the WLAN processing circuitry 229 to facilitate Wi-Fi communication. The one or more transceivers 226 is responsible for converting digital data from the WLAN processing circuitry 229 into radio signals for transmission over the air and for receiving incoming radio signals, which are then converted back into digital data for processing by the WLAN processing circuitry 229. This collaboration enables the router 220 to transmit and receive data, supporting functions such as voice calls, text messaging, Internet access, and other wireless services via Wi-Fi. The WLAN processing circuitry 229 manages the digital signal processing tasks, while the one or more transceivers 226 handle the analog RF operations, working together to enable wireless communication capabilities in the router 220.

The router 220 may include mesh network processing circuitry 236. The mesh network processing circuitry 236 is responsible for managing the transmission and reception of wireless signals to and from mobile devices (e.g., end device 210) for mesh network communication. The mesh network processing circuitry 236 can perform various signal processing tasks related to modulation, demodulation, encoding, decoding, and error correction to ensure reliable communication over the air interface. The mesh network processing circuitry 236 may execute instructions such that various operations of the router 220 are performed, as described herein. The mesh network processing circuitry 236 may include one or more processors implemented using, for example, a CPU, a DSP, an ASIC, a controller, an FPGA device, another hardware device, a firmware device, or any combination thereof configured to perform the operations described herein.

In one or more implementations, the one or more transceivers 226 can operate in conjunction with the mesh network processing circuitry 236 to facilitate mesh network communication. The one or more transceivers 226 is responsible for converting digital data from the mesh network processing circuitry 236 into radio signals for transmission over the air and for receiving incoming radio signals, which are then converted back into digital data for processing by the mesh network processing circuitry 236. This collaboration enables the router 220 to transmit and receive data, supporting functions such as audio services, Internet access, and other wireless services via the mesh network 150 of FIG. 1. The mesh network processing circuitry 236 manages the digital signal processing tasks, while the one or more transceivers 226 handle the analog RF operations, working together to enable wireless communication capabilities in the router 220.

The router 220 may include one or more antenna(s) 230 (e.g., one, two, four, or more). In implementations having multiple antenna(s) 230, the router 220 may perform multiple-in-multiple-out (MIMO), digital beamforming, analog beamforming, beam steering, etc.

The router 220 may include one or more interface(s) 227. The interface(s) 227 may be used to provide input to or output from the router 220. For example, a router 220 may include interface(s) 227 made up of transmitters, receivers, and other circuitry (e.g., other than the transceiver(s) 226/antenna(s) 230 already described) that enables the router 220 to communicate with other equipment in the mesh network 150, and/or that enables the router 220 to communicate with external networks, computers, databases, and the like for purposes of operations, administration, and maintenance of the router 220 or other equipment operably connected thereto.

The router 220 may include a polling module 228. The polling module 228 may be implemented via hardware, software, or combinations thereof. For example, the polling module 228 may be implemented as a processor, circuit, and/or instructions 225 stored in the memory 224 and executed by one or more components in the transceiver 226. In some examples, the polling module 228 may be integrated within the transceiver(s) 226. For example, the polling module 228 may be implemented by a combination of software components (e.g., executed by a DSP or a general processor) and hardware components (e.g., logic gates and circuitry) within the transceiver(s) 226. In other examples, the polling module 228 is a separate component from the transceiver(s) 226.

The router 220 may include a coexistence module 240. The coexistence module 240 may be implemented via hardware, software, or combinations thereof. For example, the coexistence module 240 may be implemented as a processor, circuit, and/or instructions 225 stored in the memory 224 and executed by one or more components in the transceiver 226. In some examples, the coexistence module 240 may be integrated within the transceiver(s) 226. For example, the coexistence module 240 may be implemented by a combination of software components (e.g., executed by a DSP or a general processor) and hardware components (e.g., logic gates and circuitry) within the transceiver(s) 226. In other examples, the coexistence module 240 is a separate component from the transceiver(s) 226.

The coexistence module 240 may be used for various aspects of the present disclosure, for example, aspects of FIG. 1 through FIG. 7. The coexistence module 240 is configured to, for example, apply one or more dynamic coexistence procedures associated with a first wireless communication protocol (e.g., mesh network). The coexistence module 240 is also configured to, for example, using the mesh network processing circuitry 236, monitor for reception of a data transmission associated with the first wireless communication protocol based at least in part on the one or more dynamic coexistence procedures.

In one or more implementations, multiple wireless communication protocols (e.g., mesh network and Bluetooth technologies) may coexist in an electronic device (e.g., electronic devices 110-112 of FIG. 1) with a shared radio that operates at 2.4 gigahertz for both Bluetooth and mesh network technologies. The integrated circuit (IC) chip responsible for modulation and demodulation, the software stack, the hardware stack, and the antennas for transmission and reception may all be shared resources between the Bluetooth and mesh network technologies. In one or more implementations, when the mesh network processing circuitry 234 is active, the Bluetooth processing circuitry 211 may not be active, and vice versa, resulting in time division multiplexing between the Bluetooth and mesh network technologies.

In one or more implementations, various techniques can be employed to enable coexistence between different wireless communication protocols without compromising quality of data. For example, an electronic device can support multiple Bluetooth audio profiles, including a music streaming service profile, a casting service profile, a video call service profile, and a cellular call service profile, without degradation in quality. For example, a user of the electronic device may be engaged in an LTE video call with audio over Bluetooth headsets while controlling home accessories with the same electronic device. These home accessories can include unlocking a door, granting access, turning on a light bulb, and/or opening a garage door, all while utilizing a shared radio with coexistence constraints. In one or more other implementations, the same radio resources between the mesh network processing circuitry 234 and the Bluetooth processing circuitry 211 may be shared without degrading the quality of the Bluetooth audio profiles.

In one or more implementations, one approach for enabling coexistence involves handling mesh network roles, specifically the sleepy end device (SED) and the synchronous sleepy end device (sSED). The data poll procedure may be used in the SED mode. In one or more implementations, the SED may connect to one of the mesh network routers (e.g., router 154) and continuously polls for incoming data. In some aspects, outgoing data can be sent from the SED at any time since the router 154 may always be powered on. In one or more other implementations, incoming data may be constrained, requiring the SED to periodically request incoming data. However, continuous reception presents challenges related to power consumption in coexistence-constrained devices such as SEDs.

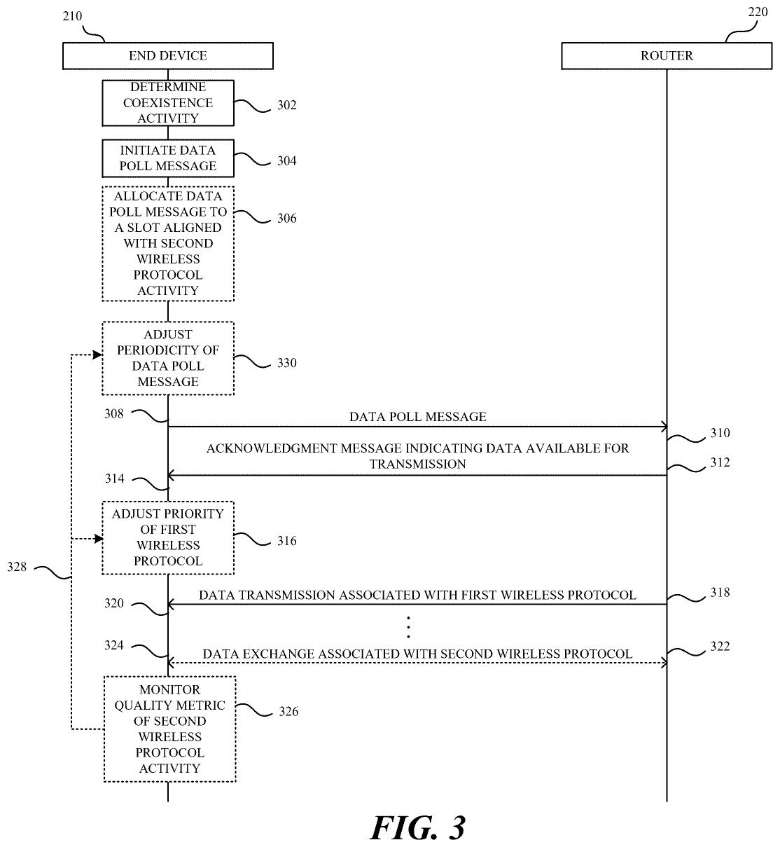

Embodiments of the subject technology provide for dynamic coexistence procedures. An apparatus may apply one or more dynamic coexistence procedures associated with a first wireless communication protocol. The apparatus also may monitor for reception of a data transmission associated with the first wireless communication protocol based at least in part on the one or more dynamic coexistence procedures. By applying these dynamic coexistence procedures, the reliability of transmissions in a mesh network is increased and coexistence between radios sharing the same frequency band can be improved. Examples of these dynamic coexistence procedures will be described with reference to FIGS. 3-7.

FIG. 3 is a schematic diagram illustrating example dynamic coexistence procedures between a router 220 (e.g., router 154 of FIG. 1 or router 156 of FIG. 1) and an end device 210 (e.g., end device 152 of FIG. 1) in accordance with one or more implementations. Embodiments of the subject technology provide for dynamic coexistence procedures that addresses challenges in mesh networks. In one or more implementations, a mesh network includes one or more SEDs that may refer to battery-powered devices and/or power-constrained devices. These types of devices may not have an always-on radio due to resource or battery constraints, which prevent continuous operation of the radio. In a mesh network, leader nodes and routers, which are main-powered devices, always remain active and listening on a communication medium. A leader node may function as a host device within a mesh network. Examples of leader nodes include devices such as smart light bulbs or security cameras, which are line-powered devices capable of acting as mesh network routers. When an electronic device such as a phone joins a mesh network, it can function as a SED because it may contain multiple radios associated with one or more wireless communication protocols, including Bluetooth, Wi-Fi, and a mesh network radio. However, all these radios may operate on the 2.4 GHz frequency, creating challenges for concurrent operation due to coexistence constraints within this frequency band.

The IEEE 802.15.4 standard may define data polling procedures between a SED serving as an end device 210 and a router serving as a router 220 to enable the end device 210 to receive incoming data from the router 220. The end device 210 can conserve power by periodically entering a sleep state. For example, if Bluetooth audio is streaming from the end device 210 to a wearable device such as an ear pod and the user attempts to unlock a door, the child device's mesh network radio may be turned off. Periodically, the end device 210 may wake up to check for incoming data. For example, the end device 210 may poll its router 220 to determine if there is any buffered data. The router 220 can respond to the child device's polling message by sending the data to the end device 210. For example, these leader nodes and/or routers, serving as parent devices for SEDs, buffer incoming data while the SEDs are in a sleep state. When a router 220 buffers data for a end device 210 (e.g., a SED), the data polling procedure involves the router 220 holding the data until the end device 210 wakes up and queries for it. If the router 220 indicates data is available, the end device 210 keeps its receiver on for a specified duration (e.g., about 200 milliseconds (ms)) while the router 220 sends the buffered data to the end device 210. If the router 220 indicates there is no data, the end device 210 immediately returns to the sleep state.

When an end device 210 has a dedicated radio, such as a standalone radio without coexistence challenges, the data polling procedure operates effectively. However, with the end device 210 implemented as a phone, there may be no dedicated radio because the radio is shared among Wi-Fi, Bluetooth, and other wireless communication protocols. As a result, the end device 210's radio may not continuously receive for a specified duration without interfering with Bluetooth activity, such as voice quality, or data streaming traffic. Continuous reception can pose significant challenges in a coexistence-constrained device, such as the end device 210. For example, these challenges arise when integrating with electronic devices such as smartphones, where radio resources are shared among various wireless technologies such as Wi-Fi and Bluetooth, posing coexistence constraints that can lead to interference with Bluetooth and Wi-Fi activities.

The dynamic coexistence procedures as described with reference to FIG. 3 optimize data reception by applying different techniques (e.g., adjusting periodicity of the data poll message, adjusting priorities, monitoring quality metrics, aligning data poll messages, adjusting CSL periodicity) when data is available for reception and/or other shared radio activities are inactive, improving coexistence and reducing the power consumption of the end device 210. This approach enhances mesh network communication technologies, offering improved performance and efficiency in coexistence-constrained environments.

At 302, the end device 210 may determine a coexistence activity between a transmitter associated with the first wireless communication protocol and a transmitter associated with a second wireless communication protocol different from the first wireless communication protocol. For example, the first wireless communication protocol may include a mesh network communication protocol and the second wireless communication protocol may include cellular, Bluetooth or Wi-Fi. In one or more implementations, the end device 210 may determine the level of activity associated with the second wireless communication protocol to determine whether transmissions of that protocol are active or not.

At 304, the end device 210 initiates a data poll message (or data request message) requesting a data transmission associated with the first wireless communication protocol. In one or more implementations, the data poll message may be generated in response to reception of a wakeup message from the router 220. In one or more other implementations, the generation of the data poll message, triggered by the end device 210, may occur in response to user-initiated actions rather than external wake-up signals. These actions, such as unlocking a door or activating a light, prompt the transmission of data poll messages. In one or more other implementations, the data poll message may be generated in response to occurrence of a predetermined time (e.g., a predetermined wakeup time).

At 306, the end device 210 may allocate the data poll message to a slot aligned with activity associated with the second wireless communication protocol. Embodiments of the subject technology provide for aligning transmissions of the first wireless communication protocol with active transmission slots of the second wireless communication protocol (e.g., Bluetooth). When a mesh network transmission is initiated such as a data poll message, the mesh network transmission can synchronize the start of its transmission slot with the end of an existing Bluetooth transmission slot, aligning the data poll message (or data request) with the end of the Bluetooth activity to avoid any overlap and improve slot allocation efficiency. In one or more implementations, the mesh network transmission containing the data poll message may not overlap with a Bluetooth transmission slot but rather aligns the start of its frame with the end of the Bluetooth activity and the mesh network processing circuitry 234 can use resources corresponding to available Bluetooth transmission slots to receive the incoming data, increasing the probability of reception when Bluetooth is active. For example, the data poll message may be transmitted at a slot that immediately follows the Bluetooth activity. This alignment between the data poll message and the Bluetooth transmission can create a longer time gap between two Bluetooth activities, allowing the mesh network processing circuitry 234 to receive incoming data more reliably. In one or more other implementations, misalignment between the data poll message and Bluetooth transmission slots can result in incoming frames arriving during Bluetooth transmission slots, causing data loss for the mesh network processing circuitry 234.

At 308, the end device 210 provides for transmission, to the router 220, the data poll message. Conversely, at 310, the router 220 receives, from the end device 210, the data poll message. In one or more implementations, data poll message may be sent using type-length-value (TLV) encoding, where the type specifies the command's length, and the value contains the command itself.

At 312, the router 220 provides for transmission, to the end device 210, an acknowledgement message indicating whether data is available for transmission to the end device 210. In one or more implementations, the router 220 may determine whether data is available for transmission to the end device 210. For example, the router 220 may determine whether there is data cached in memory of the router 220 that is intended for the end device 210. Conversely, at 314, the end device 210 receives, from the router 220, the acknowledgement message indicating whether data is available for transmission to the end device 210. In one or more implementations, the acknowledgment message indicates that data is available for transmission. For example, if data is available at the router 220, the acknowledgment message will indicate that data is ready for transmission to the end device 210 in response to the data poll message. In one or more other implementations, the acknowledgment message indicates that data is not available for transmission. In this regard, the acknowledgment message will indicate that no data is ready for transmission to the end device 210 in response to the data poll message.

At 316, the end device 210 may adjust a priority of a data reception associated with the first wireless communication protocol based at least in part on the acknowledgment message indicating that data is available for the end device 210. Embodiments of the subject technology provide for prioritizing the reception of data by the mesh network processing circuitry 234 over transmissions associated with other wireless communication protocols after the acknowledgment message (responsive to the data poll message) indicates pending data. If a parent device (e.g., the router 220) has no data pending to be sent to a child device (e.g., the end device 210), the coexistence module 238 (FIG. 2) can detect the absence of data and move to the next slot. Conversely, if the router 220 does have data pending to be sent to the end device 210, the acknowledgment message can indicate the pending data. The acknowledgment message can trigger prioritization of the pending data to the end device 210 over Bluetooth activity. Upon detecting an incoming data frame, the priority of Bluetooth slots can be dynamically adjusted to facilitate that the coexistence module 238, using the mesh network processing circuitry 234, can receive data throughout the timeframe available for reception of the data.

In one or more implementations, the Bluetooth processing circuitry 211 for data transmission can be assigned a higher priority than the mesh network processing circuitry 234 for data reception within slots allocated for Bluetooth activity. In one or more other implementations, if an incoming data frame is detected with the acknowledgment message, the mesh network processing circuitry 234 can dynamically adjust its priority over the Bluetooth processing circuitry 211 to facilitate reception of an entire data frame from the router 220 within a specified duration. In one or more implementations, both radios (e.g., the Bluetooth processing circuitry 211 and the mesh network processing circuitry 234) may be aware of these priorities, with a controller (e.g., the host processor 213) serving to arbitrate between them. In one or more implementations, the host processor 213 may be cognizant of the priority levels assigned to both tasks and Bluetooth operations, facilitating coordination between them. Despite potential Bluetooth packet losses, the Bluetooth processing circuitry 211 may not engage in adaptation, leaving such adjustments to mesh network operations to mitigate potential issues between the radios.

In one or more implementations, the host processor 213 and/or the mesh network processing circuitry 234 may determine a sequence of priorities based on time allocation. For example, each task may be assigned a priority, and tasks with higher priority may be scheduled first in the sequence. In cases where multiple tasks compete for execution in a same time slot, higher priority tasks may preempt lower priority tasks. For example, if a Bluetooth transmission fails, a retransmission task with higher priority can take precedence over other tasks. In one or more other implementations, if an acknowledgment message indicates an incoming transmission (or data is available to be transmitted), the host processor 213 and/or the mesh network processing circuitry 234 can adjust priorities, elevating the mesh network task's priority to facilitate readiness of the mesh network processing circuitry 234. Once a priority is raised, tasks with lower priority can be suspended until the higher priority task is completed or its priority is lowered. This adjustment in priority allows previously suspended tasks to be reconsidered for execution. In one or more other implementations, the priority may be adjusted by the mesh network processing circuitry 234, while its configuration is managed by the host processor 213. This division may be due to the time-critical nature of the processes, with the execution of such tasks occurring in the mesh network processing circuitry 234, while policy adjustments are downloaded by the host processor 213.

In one or more implementations, if the priorities are identical between two radios (e.g., the mesh network processing circuitry 234 and the Bluetooth processing circuitry 211 have the same priority), the Bluetooth processing circuitry 211 may take precedence over the mesh network processing circuitry 234. In one or more other implementations, if two tasks have the same priority, then the task that has been in the queue for a longer period of time can be given priority over the other task.

In one or more implementations, the end device 210 may monitor for reception of a data transmission associated with the first wireless communication protocol (e.g., mesh network transmission) from the router 220 based at least in part on the adjusted priority. In one or more other implementations, the end device 210 may activate a receiver associated with the first wireless communication protocol (e.g., mesh network radio receiver) during at least one of the one or more available time slots in the time window in accordance with the adjusted priority. In one or more other implementations, the end device 210 may transition into a sleep state (or low power state) based on the acknowledgment message indicating that data is not available for transmission to the end device 210.

At 318, the router 220 provides for transmission, to the end device 210, the data transmission associated with the first wireless communication protocol. Conversely, at 320, the end device 210 receives, from the router 220, the data transmission associated with the first wireless communication protocol.

At 322, the router 220 may facilitate a data exchange associated with the second wireless communication protocol with the end device 210. Conversely, at 324, the end device 210 may facilitate a data exchange associated with the second wireless communication protocol with the router 220.

At 326, the end device 210 may monitor a quality metric of one or more data transmissions associated with the second wireless communication protocol. Embodiments of the subject technology provide for monitoring a quality metric (e.g., mean opinion score (MOS) value) that measures audio quality of incoming data traffic and/or outgoing data traffic. This approach can maintain an acceptable quality metric for electronic devices through real-time adaptation based on data traffic metrics for different wireless communication protocols. For example, this approach may avert the quality metric from dipping below a quality threshold in the event of a missing frame. At the conclusion of block 326, information about the quality metric can be provided to block 326 and/or to block 330 for dynamic adjustments to optimize coexistence behavior. In one or more implementations, at 330, this approach may involve dynamically adjusting the periodicity of the data poll message based on feedback from Bluetooth audio, which can indicate an active Bluetooth profile. In one or more implementations, closed-loop feedback control signaling can include the quality metric such as the MOS value to indicate how to adjust the data traffic associated with the first wireless communication protocol (e.g., mesh network). In one or more implementations, the recorded feedback can inform mesh network behavior adjustments based on Bluetooth performance metrics (e.g., Bluetooth MOS value), facilitating optimal performance throughout mesh network activities.

In one or more implementations, the quality metric can be determined by the number of frames received and the number of frames missing (e.g., frames not received). For example, if the Bluetooth processing circuitry 211 detects a dynamic increase in priority for transmissions associated with another wireless communication protocol (e.g., mesh network protocol), this may result in a missed Bluetooth slot, causing interference with Bluetooth traffic. If only one slot is missed, the Bluetooth audio can employ one or more algorithms such as packet error concealment to interpolate the missing audio. In one or more other implementations, if multiple slots are missed, interpolation of the missing audio can fail, causing glitches and noise and thus leading to a decrease in audio quality.

In one or more implementations, subjective and objective tests can be conducted for audio evaluation. Both subjective and objective tests are used to assess Bluetooth audio quality, with MOS values providing more meaningful data. The subjective test can measure glitches perceived during audio transmission, which may vary based on individual hearing sensitivities and perceptions. The objective test can quantify missed slots in audio transmission. In one or more implementations, the Bluetooth processing circuitry 211 can employ an algorithm that analyzes Bluetooth data packets to assess transmission integrity, considering packet loss and concealment effectiveness. In one or more implementations, the algorithm can cause a predetermined audio pattern to be transmitted between devices to detect frame loss, with MOS values being calculated over a specific time window. In one or more implementations, MOS values can be in a range from one to five, with five indicating very good audio quality and a specified value (e.g., 2.5) representing a quality threshold for acceptable quality. MOS values below the quality threshold of 2.5 may indicate poor audio quality, which is undesirable.

In one or more other implementations, variations in the MOS values can be detected due to interference between two or more wireless communication protocols. In some aspects, the quality metric (e.g., the MOS value) of a Bluetooth transmission may decrease below the quality threshold due to mesh network interference. For example, as the mesh network processing circuitry 234 stops transmissions, the quality metric increases for a duration that the mesh network processing circuitry 234 is not operating but drops again when the mesh network processing circuitry 234 restarts transmissions, indicating poor audio quality due to periodic glitches in the Bluetooth transmissions. In one or more other implementations, the mesh network processing circuitry 234 can monitor the number of Bluetooth audio packets dropped and adjusts its operation accordingly. If significant packet loss is detected, the mesh network processing circuitry 234 can decrease its rate of transmissions or pause its transmissions to allow the Bluetooth audio traffic to recover. Once the Bluetooth audio quality improves, the mesh network processing circuitry 234 can resume its operation. As illustrated in FIG. 3, feedback 328 can serve as feedback signaling that causes an adjustment to the priority and/or periodicity of data reception and/or data transmissions associated with the first wireless communication protocol. For example, if the MOS value is greater than 4, the periodicity of the data poll message can be adjusted to be about 60 ms, whereas if the MOS value is greater than 3 and less than 4, the periodicity of the data poll message can be adjusted to be about 120 ms, or alternatively, if the MOS value is less than 3, the periodicity of the data poll message can be adjusted to be about 420 ms.

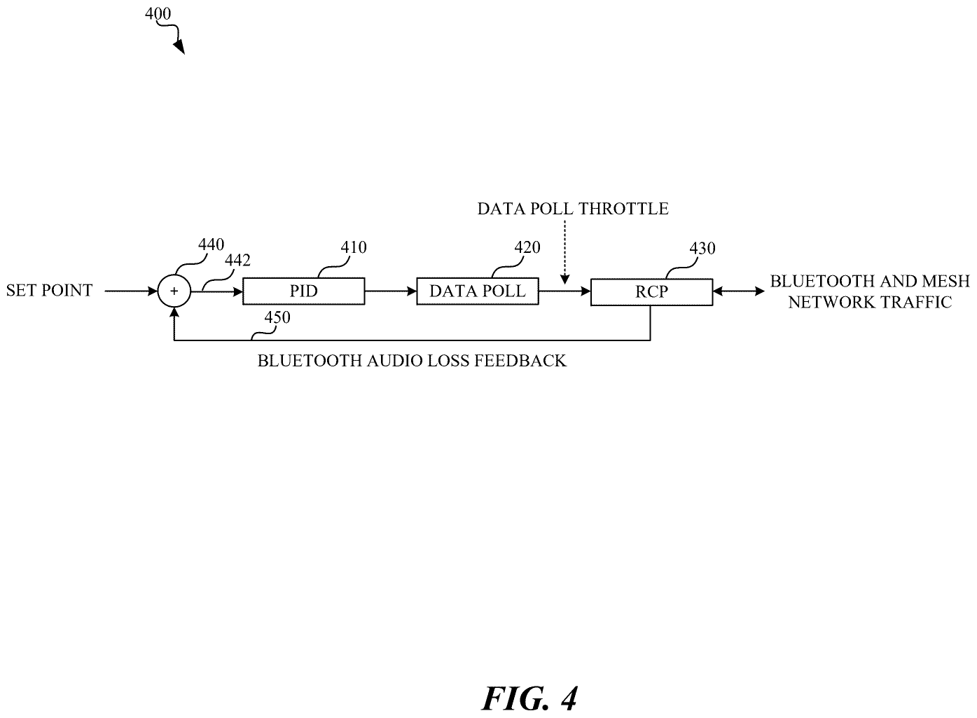

FIG. 4 is a schematic diagram of an example closed-loop audio feedback mechanism 400 in accordance with one or more implementations. In one or more implementations, the closed-loop audio feedback mechanism 400 integrates a proportional-integral-derivative (PID) controller 410 connected to a data poll throttler 420. The data poll throttler 420 may interface with radio coprocessor (RCP) module 430. In one or more implementations, the RCP module 430 may be a specialized processing unit configured to handle RF tasks independently of a main central processing unit (e.g., host processor 213) in a device (e.g., end device 210). The RCP module 430 may be responsible for managing computationally intensive operations involved in wireless communication, such as signal modulation and demodulation, encoding and decoding of data, error correction, and protocol handling. The RCP module 430 may be configured to interface with and/or manage Bluetooth and mesh network traffic. In one or more implementations, the RCP module 430 is the radio that is shared between the mesh network and Bluetooth and is aware of Bluetooth audio loss metrics based on the mesh network activity. The RCP module 430 can generate an audio loss feedback signal 450, indicative of Bluetooth audio loss feedback, and shares the Bluetooth audio loss feedback to a control system (e.g., mesh network processing circuitry 234 and/or the polling module 218) to adjust the data poll behavior. This audio loss feedback signal 450 may be directed to a summation operator 440. The PID controller 410 may receive a summation signal 442 from the summation operator 440, which can be a combination of a set point signal and the feedback signal 450. The output of the summation operator 440 can serve as the input to the PID controller 410. For example, the summation operator 440 can produce the summation signal 442 and send it to the PID controller 410 as an input. This closed-loop feedback mechanism allows the PID controller 410 to adjust the periodicity of the data poll message via the data poll throttler 420 based on the discrepancies between the set point signal and the audio loss feedback signal 450, facilitating managing Bluetooth audio loss within the coexistence context.

In one or more implementations, the MOS values may be obtained over a defined period, such as a 10-second measurement window, where the number of lost packets can be monitored. If a trend of increasing packet loss is detected within the measurement window, the trend may indicate a potential decline in performance. This information may trigger the closed-loop feedback mechanism 400 to adjust the data transmission rate (e.g., data poll periodicity) at the mesh network processing circuitry 234. In one or more implementations, feedback about Bluetooth audio loss may prompt adjustments to maintain performance within acceptable limits, such as keeping the MOS values above the quality threshold during at least the measurement window. In one or more other implementations, various algorithms, such as sliding window averages or PID controllers (e.g., PID controller 410), may be employed to dynamically adjust the transmission rate based on measured losses. The closed-loop audio feedback mechanism 400 can help optimize performance by adjusting the transmission rate to mitigate losses and stabilize performance.

In one or more implementations, monitoring the quality metric can ensure that data points remain above the quality threshold by facilitating that both technologies (or wireless communication protocols) meet respective key performance indicators (KPIs) while coexisting. The quality threshold may be fixed (or set to a predetermined threshold value), while dynamic adjustments are made within the system, including changes to mesh network operations, data polling intervals and/or priorities, to ensure that all measurements remain above the quality threshold.

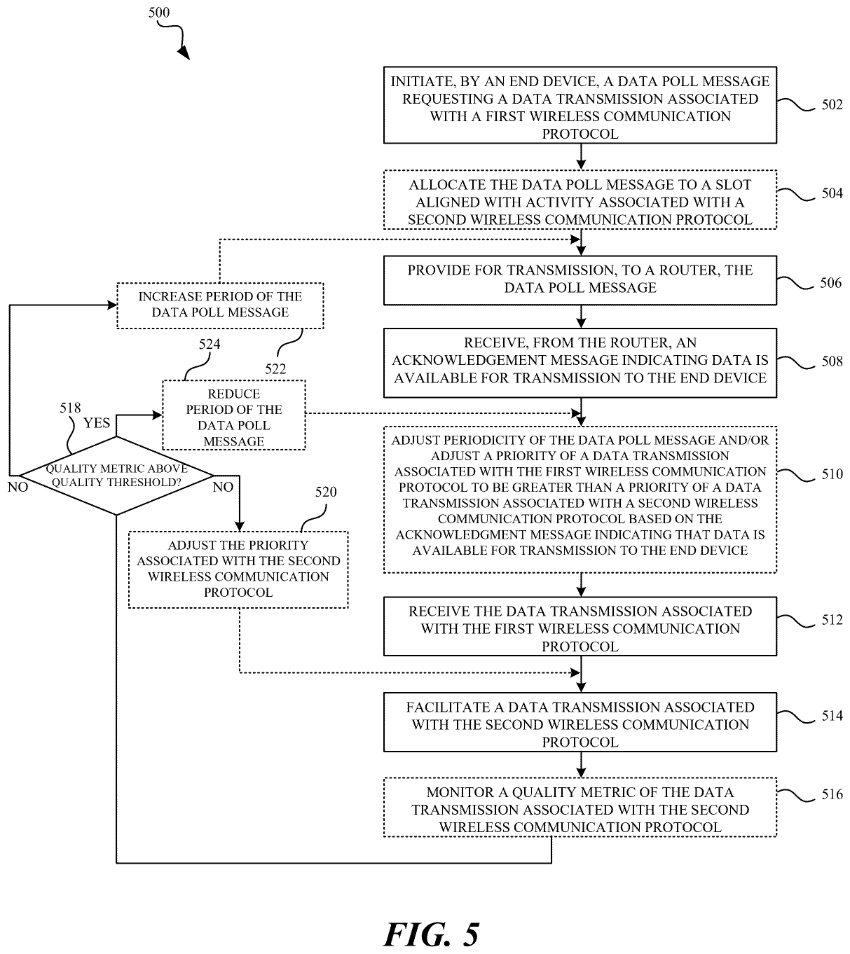

FIG. 5 is a flow chart of an example process 500 that may be performed by processing circuitry of an end device for dynamic coexistence procedures in accordance with one or more implementations. For explanatory purposes, the process 500 is primarily described herein with reference to an apparatus. However, the process 500 is not limited to the apparatus, and one or more blocks (or operations) of the process 500 may be performed by one or more other components of other suitable devices and/or servers. Further for explanatory purposes, some of the blocks of the process 500 are described herein as occurring in serial, or linearly. However, multiple blocks of the process 500 may occur in parallel. In addition, the blocks of the process 500 need not be performed in the order shown and/or one or more blocks of the process 500 need not be performed and/or can be replaced by other operations.

In one or more implementations, the apparatus of FIG. 5 includes a mesh network processor (e.g., mesh network processing circuitry 234 of FIG. 2) coupled to a RF transceiver (e.g., one or more transceivers 216 of FIG. 2). The apparatus communicates using the mesh network processor through the RF transceiver with other end devices and/or routers. In one or more implementations, the apparatus is the entire end device (e.g., end device 210) and includes additional radios (e.g., cellular processing circuitry 212, Bluetooth processing circuitry 211, WLAN processing circuitry 219, mesh network processing circuitry 234).

In one or more implementations, the apparatus may monitor a coexistence between activity associated with a first wireless communication protocol (e.g., mesh network) and activity associated with a second wireless communication protocol (e.g., Bluetooth, Wi-Fi, among others). As illustrated in FIG. 5, at block 502, the apparatus initiates a data poll message requesting a data transmission associated with the first wireless communication protocol.

At block 504, optionally, the apparatus may apply one or more dynamic coexistence procedures associated with the first wireless communication protocol by allocating the data poll message to a slot aligned with activity associated with a second wireless communication protocol.

At block 506, the apparatus provides for transmission, to a parent device (e.g., router 154, router 156 of FIG. 1; router 220 of FIG. 2; parent device 320 of FIG. 3), the data poll message. At block 508, the apparatus receives, from the parent device, an acknowledgement message indicating whether data is available for transmission to the apparatus. In one or more implementations, the apparatus may monitor for a data transmission associated with the first wireless communication protocol based on the acknowledgment message indicating that data is available for transmission to the apparatus. In one or more other implementations, the apparatus may transition into a sleep state based on the acknowledgment message indicating that no data is available for transmission to the apparatus.

At block 510, optionally, the apparatus may apply one or more dynamic coexistence procedures associated with the first wireless communication protocol by adjusting a priority of the data transmission associated with the first wireless communication protocol to be different than a priority of a data transmission associated with the second wireless communication protocol. In one or more implementations, the priority of the data transmission associated with the first wireless communication protocol may be adjusted to be greater than the priority of the data transmission associated with the second wireless communication protocol based at least in part on the acknowledgment message indicating that data is available for transmission to the apparatus. In this regard, data reception associated with the first wireless communication protocol during a slot originally allocated to the second wireless communication protocol can take precedence over the second wireless communication protocol. In one or more other implementations, the priority of the data transmission associated with the first wireless communication protocol may be adjusted based at least in part on a level of activity associated with the second wireless communication protocol.

At block 512, the apparatus may receive the data transmission associated with the first wireless communication protocol. At some time after, at block 514, the apparatus can facilitate a data transmission associated with the second wireless communication protocol.

At block 516, the apparatus may measure and/or monitor a quality metric (e.g., MOS value) of the data transmission associated with the second wireless communication protocol. At block 518, the apparatus can determine whether the quality metric is above a quality threshold (e.g., 2.5 MOS value). If the quality metric is above the quality threshold, then the process 500 can, optionally, proceed to block 524. At the conclusion of block 524, the process 500 proceeds to block 510. For example, the priority of the data transmission associated with the first wireless communication protocol can be adjusted to be greater than the priority of one or more data transmissions associated with the second wireless communication protocol based at least in part on the quality metric satisfying the quality threshold. At block 524, for example, the apparatus can reduce the period of the data poll message to increase the frequency of data polling based at least in part on the quality metric satisfying the quality threshold. Otherwise, the process 500 proceeds to block 520 and/or block 522. At block 520, the apparatus may, optionally, adjust the priority associated with the second wireless communication protocol to be greater than the priority of the first wireless communication protocol. At block 522, the apparatus may, optionally, adjust the periodicity of the data poll message so that any interference onto activity associated with the second wireless communication protocol caused by activity associated with the first wireless communication protocol can be reduced. In one or more implementations, the period of the data poll message is reduced based at least in part on the quality metric satisfying the quality threshold. For example, if the MOS value is greater than 4, the period of the data poll message can be adjusted to be about 60 ms. In one or more other implementations, the period of the data poll message is increased based at least in part on the quality metric not satisfying the quality threshold. For example, if the MOS value is greater than 3 and less than 4, the period of the data poll message can be adjusted to be about 120 ms, or alternatively, if the MOS value is less than 3, the period of the data poll message can be adjusted to be about 420 ms. In one or more implementations, the process 400 may proceed to block 522 instead of to block 520 if the quality metric is above a certain quality threshold (e.g., MOS value is greater than 3). In one or more other implementations, the process 400 may proceed to block 520 instead of to block 522 if the quality metric is less than a certain quality threshold (e.g., MOS value is less than 3). In one or more other implementations, the process 400 may proceed to both blocks 520 and 522 if the quality metric is greater than a certain quality threshold (e.g., MOS value is greater than 2.5).

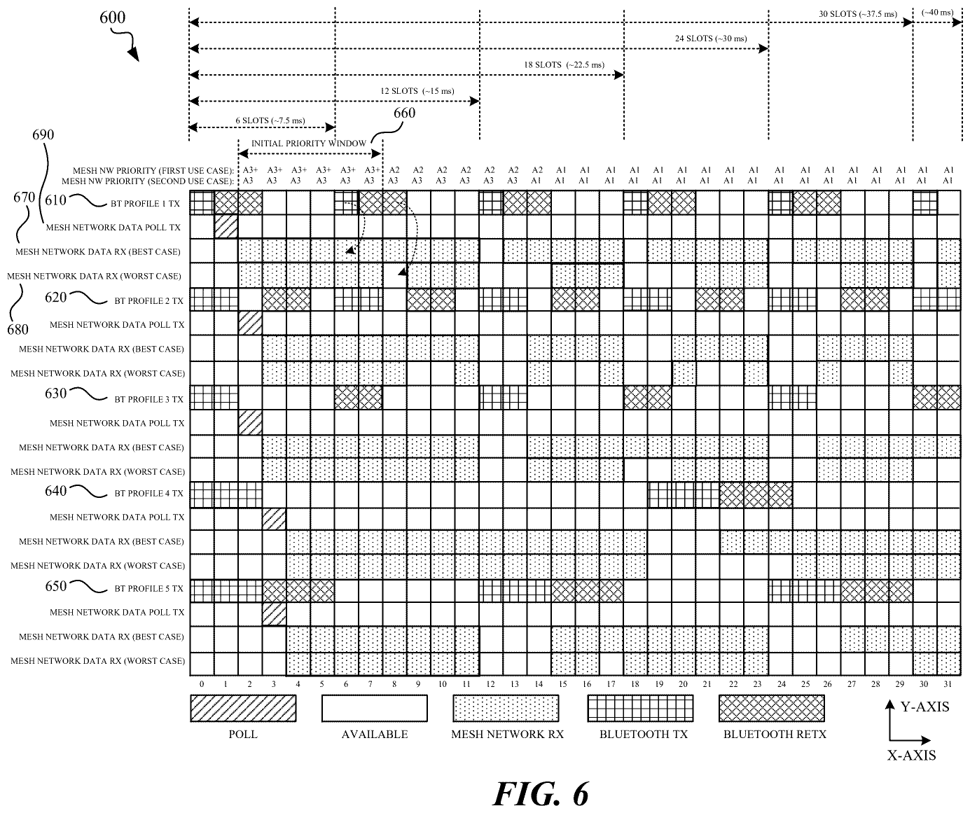

FIG. 6 conceptually illustrates an example of a resource grid 600 with an example dynamic coexistence procedure in accordance with one or more implementations. In one or more implementations, the x-axis of the resource grid 600 represents time divided into time slots, each slot about 1.25 ms long, while the y-axis of the resource grid 600 represents different Bluetooth profiles during various activities. Each time slot may be used by a Bluetooth radio to send one frame. Bluetooth transmissions may be interleaved to avoid overlapping. Each Bluetooth profile may transmit data in specific slots, with retransmissions occurring in subsequent slots if needed. This arrangement of time slots facilitates efficient use of the Bluetooth radio.

The Bluetooth profiles may include a profile used for LTE calls on wearable audio devices (e.g., Bluetooth profile 610). For a phone, the resource grid 600 shows a transmission pattern for the Bluetooth profile 610 (e.g., represented as BT profile 1 TX) that includes a first time slot (e.g., slot 0) as a primary Bluetooth time slot and the next two being Bluetooth retransmission slots (e.g., slots 1 and 2). As illustrated in FIG. 6, the transmission pattern may repeat approximately every 6 time slots (or about 7.5 ms). For example, during a voice call over Long-Term Evolution (LTE) on a phone while listening to Bluetooth audio through one or more wearable listening devices (e.g., Bluetooth profile 610), the Bluetooth profile 610 is active. In this case, the Bluetooth connection may use a Bluetooth transmission slot to transmit data from the phone to the wearable devices. If needed, the phone may retransmit the audio data in subsequent slots using the Bluetooth retransmission slots. The Bluetooth profiles also include a profile used for audio devices for impaired hearing (e.g., Bluetooth profile 620), a profile used for a streaming music service (e.g., Bluetooth profile 630), and/or a profile used for video calls (e.g., Bluetooth profile 640).

As illustrated in FIG. 6, the resource grid 600 involves the coexistence between a mesh network wireless communication protocol and Bluetooth, both of which may operate on the same radio frequency (e.g., 2.4 GHz). Their coexistence may necessitate non-overlapping usage of resources to avoid interference between the two wireless communication protocols. When a transmitter associated with the mesh network protocol initiates a poll message (or data poll message), such as when a SED needs to unlock a door, it requests incoming data. According to the IEEE 802.15.4 specification, the SED may need to wait for up to 100 ms to receive the data. The resource grid 600 illustrates time intervals during which the device is waiting for incoming data (denoted as M esh Network Data RX). Concurrently, other Bluetooth activities may need to be coordinated to avoid conflicts. Each accessory has specific slots assigned for communication to facilitate seamless operation within the shared 2.4 GHz frequency band. In one or more implementations, each of the Bluetooth profiles may be allocated with a number of resources that includes a sequence of two or more consecutive time slots and a repetition of the sequence at periodic intervals. For example, one of the Bluetooth profiles is allocated with a sequence that includes three primary slots for initial transmission followed by one or more retransmission slots (e.g., Bluetooth profiles 640, 650).

In Bluetooth, time slot allocation may vary depending on the specific use case, such as audio transmission or low-latency human interface devices. These resource allocations may accommodate different types of data transmission. In one or more other implementations, a challenge arises when multiple Bluetooth activities are active simultaneously, particularly concerning the integration of mesh network traffic with the Bluetooth traffic. When all Bluetooth activities are active, the available time slots in the resource grid 600 for the mesh network processing circuitry 234 to receive data may be limited to retransmission slots or empty time slots. The reliability of the mesh network radio reception in the presence of Bluetooth coexistence becomes a significant challenge. The probability of receiving a frame by the mesh network radio may be dependent on whether the frame transmission falls within a free time slot. If the frame transmission aligns with a Bluetooth slot, reception may not occur. In one or more other implementations, if the frame transmission aligns with an empty time slot, reception may be possible. The probability of reception may be calculated as the number of free time slots divided by the total number of time slots in the resource grid 600.

In one or more implementations, challenges associated with coexistence between radios involve the timing of the receipt of a frame by one of the radios, which can arrive at any point. These challenges can be addressed by at least one of the dynamic coexistence procedures that can include aligning a data poll message (or data request) with an end of a time slot allocated for a Bluetooth transmission. Embodiments of the subject technology provide for aligning transmissions of the first wireless communication protocol with active transmission slots of the second wireless communication protocol (e.g., Bluetooth). When a mesh network transmission is initiated such as a data poll message 690, the mesh network transmission should synchronize its transmission slot with an existing Bluetooth transmission slot, aligning the data poll message 690 with the Bluetooth activity. For example, the data poll message 690 may be transmitted at a slot (e.g., slot 1) that immediately follows Bluetooth activity (e.g., Bluetooth transmission associated with Bluetooth profile 610 at slot 0). This alignment between the data poll message 690 and the Bluetooth transmission can create a longer time gap between two Bluetooth activities, allowing the mesh network processing circuitry 234 to receive incoming data more reliably. In one or more other implementations, misalignment between the data poll message 690 and Bluetooth transmission slots can result in incoming frames arriving during Bluetooth transmission slots, causing data loss for the mesh network processing circuitry 234.

In one or more implementations, the first wireless communication protocol such as the mesh network can include a priority assigned to data reception and/or data transmission tasks. In one or more implementations, the mesh network processing circuitry 234 may determine that data is pending based on the data poll message 690 sent to a parent device (e.g., router 154, router 156) at slot 1, resulting in the mesh network traffic having a higher priority than the Bluetooth traffic associated with the Bluetooth profile 610 for slots 2-7. This can result in a Bluetooth transmission associated with the Bluetooth profile 610 being missed at slot 6. In this regard, the mesh network processing circuitry 234 takes precedence, resulting in the utilization of slot 6 as mesh network slot instead. In one or more other implementations, if an acknowledgment message within the second Bluetooth profile indicates an incoming mesh network frame, the priority of the mesh network processing circuitry 234 over the Bluetooth processing circuitry 211 is increased. Consequently, two slots allocated for Bluetooth transmissions may be overwritten and missed by the Bluetooth processing circuitry 211 due to the higher priority assigned to the mesh network processing circuitry 234.

The mesh network priority may be defined by specific notations (e.g., A 3+, A3, A2, A1), which represent different priority levels. For example, the notation A 3+ may represent the highest priority, followed by A3 then A2 and then A1, where the notation A1 represents the lowest priority. After transmission of the data poll message 690 at slot 1 and upon detecting an incoming frame at slot 2, the mesh network priority remains set to a priority level of A 3+ for a duration of the initial priority window 660, after which the mesh network priority gradually decreases (as illustrated along the x-axis of the resource grid 600).

The resource grid 600 in FIG. 6 also illustrates best-case and worst-case scenarios associated with each mesh network data poll transmission to demonstrate the probability outcomes of data reception by the mesh network processing circuitry 234 at slots associated with different Bluetooth profiles. In one or more implementations, a best-case scenario 670 (denoted as Mesh Network Data RX Best Case) is defined by an initial priority window 660 of 6 slots (or about 7.5 ms), indicating the duration at which the priority of the mesh network processing circuitry 234 for receiving data is increased over the priority for Bluetooth traffic. In one or more other implementations, a worst-case scenario 680 (denoted as Mesh Network Data RX Worst Case) is defined by the initial priority window 660, indicating the duration at which the priority of the mesh network processing circuitry 234 for receiving data is at or below the priority for Bluetooth traffic. Beyond the initial priority window 660, the retransmission slot associated with the Bluetooth profile 610, for example at slot 8, may instead be handled by the Bluetooth processing circuitry 211 as the high priority for the mesh network processing circuitry 234 may no longer apply. In one or more implementations, after the initial priority window 660, the priority of the mesh network processing circuitry 234 for receiving data may be decreased to a specified priority or a default priority value that is lower than the priority for Bluetooth traffic. In one or more other implementations, the initial priority window 660 may be defined by an associated period of reception for the mesh network processing circuitry 234, and once the associated period of reception expires, the initial priority window 660 may cease to apply.

FIG. 7 is a schematic diagram illustrating an example dynamic coexistence procedure between the end device 210 and a sleepy router 720 in accordance with one or more implementations. In one or more implementations, the sleepy router 720 employs CSL to manage its low-power state and periodic wake-up schedule. In its low-power operation mode, the sleepy router 720 can periodically wake up at pre-determined intervals (e.g., CSL periods) to check for any incoming data transmissions from other devices in the mesh network 150. During these wake-up periods, the sleepy router 720 can listen for data packets that may require forwarding or processing. This procedure may allow the sleepy router 720 to conserve energy by remaining in a low-power sleep state for most of the time and becoming active during these brief listening windows.

At block 702, the sleepy router 720 may determine a coexistence activity between a transmitter associated with the first wireless communication protocol (e.g., mesh network) and a transmitter associated with a second wireless communication protocol (e.g., cellular, Bluetooth or Wi-Fi). In one or more implementations, the sleepy router 720 may determine the level of activity associated with the second wireless communication protocol to determine whether transmissions of that protocol are active or not.

At block 704, the sleepy router 720 may adjust a CSL periodicity based on the determined coexistence activity. Embodiments of the subject technology provide for dynamically adjusting the periodicity of CSL for mesh network data reception based on activity associated with other wireless communication protocols. By adjusting the CSL period, the sleep router 720 can balance the trade-offs between power consumption and communication latency, maintaining efficient network operations without the need for constant active polling.

In one or more implementations, the dynamic adjustment of the CSL periodicity can be implemented with a sleepy router configuration. In one or more implementations, a sleepy router configuration may refer to a network setup where one or more routers 154 in the mesh network 150 are allowed to enter a low-power sleep mode to conserve energy when they are not actively transmitting or receiving data. For example, the electronic device 110 (e.g., a phone) may have direct communication with a battery-powered device (or end device 152 of FIG. 1), such as a door lock, without connection to a router (e.g., router 154 of FIG. 1), functioning as a sleepy router.

In one or more implementations, the host processor 223 and/or the mesh network processing circuitry 236 monitors the type and status of the Bluetooth profile to determine operational periods. In one or more implementations, the mesh network processing circuitry 236 and the Bluetooth processing circuitry 221 coordinate with each other such that when Bluetooth activity is detected, the mesh network processing circuitry 236 adapts its slot allocation accordingly. The mesh network processing circuitry 236 can prioritize these slots during polling, ensuring that only one slot can be allocated per event to maintain seamless audio transmission. In one or more other implementations, the periodicity of CSL can be controlled based on Bluetooth slot misses, with adjustments made to the CSL periodicity to optimize performance. In one or more implementations, the CSL periodicity is fixed. In one or more other implementations, the CSL periodicity is dynamically adjustable. For example, the CSL period can be adjusted to avoid interference between the Bluetooth transmission and mesh network transmission. This dynamic adjustment in slot allocation is based on the load imposed by Bluetooth. In one or more implementations, these activities may include managing mesh network requests scheduled in time slots and adjusting the CSL periodicity based on Bluetooth activity, dynamically adjusting when Bluetooth becomes active or inactive. In one or more implementations, the state information from the Bluetooth audio feedback can be used to adjust the periodicity of the CSL. When there is no Bluetooth activity, the CSL periodicity can be increased to run the mesh network data reception at a faster rate.

In one or more other implementations, the CSL period may be set to a default CSL period (e.g., 60 ms with Bluetooth activity; 20 ms or 40 ms with no Bluetooth activity and Wi-Fi activity). The default CSL period can align with Bluetooth activity to ensure there is no overlap in connections, avoiding interference. In one or more implementations, the CSL period may be set to an adjusted CSL period (e.g., 20 ms). For example, if the Bluetooth processing circuitry 211 is not active, there may be no need for the default CSL period, and the mesh network processing circuitry 234 can utilize the adjusted CSL period instead. In scenarios where the Bluetooth processing circuitry 211 is already active at startup, the mesh network processing circuitry 234 employs the default CSL period, allowing for accurate scheduling of the mesh network packets in view of the Bluetooth traffic. Conversely, when the Bluetooth processing circuitry 211 becomes active during operation, the interval dynamically switches from the adjusted CSL period to the default CSL period to accommodate the change in Bluetooth activity. This dynamic adjustment facilitates efficient utilization of resources based on real-time conditions.

At block 706, the sleepy router 720 may monitor for a data transmission associated with the first wireless communication protocol based on the adjusted CSL period. For example, the sleepy router 720 may become active according to the adjusted CSL period. At block 708, the end device 210 may provide for transmission, to the sleep router 720, the data transmission associated with the first wireless communication protocol. Conversely, at block 710, the sleepy router 720 receives the data transmission associated with the first wireless communication protocol.

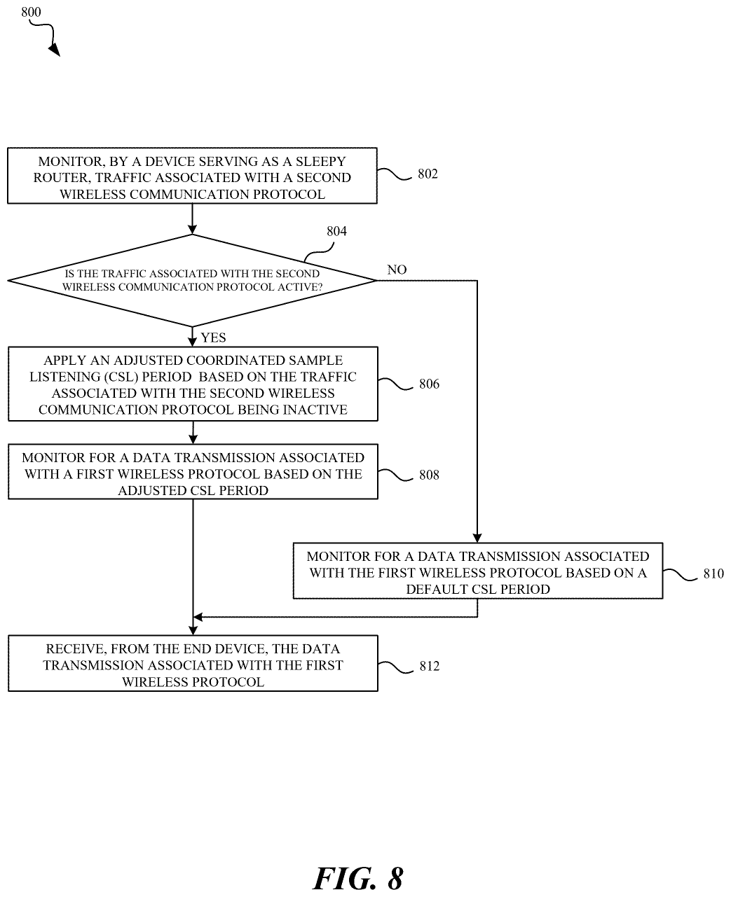

FIG. 8 is a flow chart of an example process 800 that may be performed by processing circuitry of a sleepy router device for dynamic coexistence procedures in accordance with one or more implementations. For explanatory purposes, the process 800 is primarily described herein with reference to the an apparatus. However, the process 800 is not limited to the apparatus, and one or more blocks (or operations) of the process 800 may be performed by one or more other components of other suitable devices and/or servers. Further for explanatory purposes, some of the blocks of the process 800 are described herein as occurring in serial, or linearly. However, multiple blocks of the process 800 may occur in parallel. In addition, the blocks of the process 800 need not be performed in the order shown and/or one or more blocks of the process 800 need not be performed and/or can be replaced by other operations.

In one or more implementations, the apparatus of FIG. 8 includes a mesh network processor (e.g., mesh network processing circuitry 236 of FIG. 2) coupled to a RF transceiver (e.g., one or more transceivers 226 of FIG. 2). The apparatus communicates using the mesh network processor through the RF transceiver with other end devices and/or routers. In one or more implementations, the apparatus is the entire router (e.g., router 220) and may include additional radios (e.g., cellular processing circuitry 222, Bluetooth processing circuitry 221, WLAN processing circuitry 229, mesh network processing circuitry 236).

As illustrated in FIG. 8, at block 802, the apparatus monitors for traffic associated with a second wireless communication protocol. At block 804, the apparatus determines whether the monitored traffic associated with the second wireless communication protocol is active. If the traffic associated with the second wireless communication protocol is not active, then the process 800 proceeds to block 810. Otherwise, the process 800 proceeds to block 806. In this regard, the apparatus can adjust the CSL period to optimize the coexistence between radios sharing the same frequency band.

At block 806, the apparatus applies an adjusted CSL period based on the traffic associated with a second wireless communication protocol being inactive. In this regard, for example, Bluetooth slots that are inactive with Bluetooth traffic may be repurposed to increase the rate of transmission of data associated with the first wireless communication protocol.

At block 808, the apparatus monitors for activity associated with the first wireless communication protocol based on the adjusted CSL period. Subsequently, at block 812, the apparatus receives, from the end device 210, the data transmission associated with the first wireless communication protocol within the adjusted CSL period.

In one or more other implementations, at block 810, the apparatus monitors for activity associated with the first wireless communication protocol based on a default CSL period when the activity associated with the second wireless communication protocol is not active. Subsequently, at block 812, the apparatus receives, from the end device 210, the data transmission associated with the first wireless communication protocol within the default CSL period.

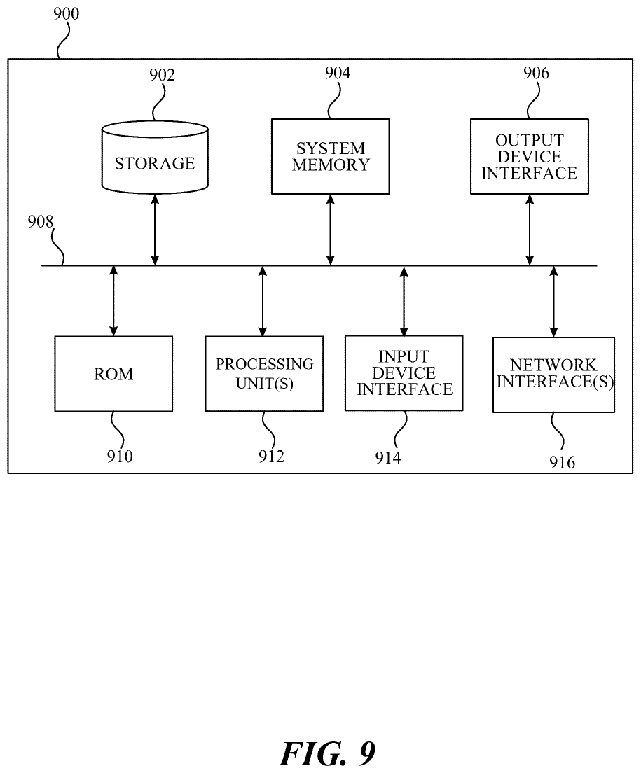

FIG. 9 illustrates an electronic system 900 with which one or more implementations of the subject technology may be implemented. The electronic system 900 can be, and/or can be a part of, any one of the electronic devices 110-112 and/or the server 120 shown in FIG. 1; the end device 210 and/or the router 220 shown in FIG. 2; the child device 310 and/or the parent device 320 shown in FIG. 3. The electronic system 900 may include various types of computer readable media and interfaces for various other types of computer readable media. The electronic system 900 includes a bus 908, one or more processing unit(s) 912, a system memory 904 (and/or buffer), a ROM 910, a permanent storage device 902, an input device interface 914, an output device interface 906, and one or more network interfaces 916, or subsets and variations thereof.

The bus 908 collectively represents all system, peripheral, and chipset buses that communicatively connect the numerous internal devices of the electronic system 900. In one or more implementations, the bus 908 communicatively connects the one or more processing unit(s) 912 with the ROM 910, the system memory 904, and the permanent storage device 902. From these various memory units, the one or more processing unit(s) 912 retrieves instructions to execute and data to process in order to execute the processes of the subject disclosure. The one or more processing unit(s) 912 can be a single processor or a multi-core processor in different implementations.

The ROM 910 stores static data and instructions that are needed by the one or more processing unit(s) 912 and other modules of the electronic system 900. The permanent storage device 902, on the other hand, may be a read-and-write memory device. The permanent storage device 902 may be a non-volatile memory unit that stores instructions and data even when the electronic system 900 is off. In one or more implementations, a mass-storage device (such as a magnetic or optical disk and its corresponding disk drive) may be used as the permanent storage device 902.

In one or more implementations, a removable storage device (such as a flash drive, and its corresponding solid-state drive) may be used as the permanent storage device 902. Like the permanent storage device 902, the system memory 904 may be a read-and-write memory device. However, unlike the permanent storage device 902, the system memory 904 may be a volatile read-and-write memory, such as random-access memory. The system memory 904 may store any of the instructions and data that one or more processing unit(s) 912 may need at runtime. In one or more implementations, the processes of the subject disclosure are stored in the system memory 904, the permanent storage device 902, and/or the ROM 910. From these various memory units, the one or more processing unit(s) 912 retrieves instructions to execute and data to process in order to execute the processes of one or more implementations.

The bus 908 also connects to the input device interface 914 and output device interface 906. The input device interface 914 enables a user to communicate information and select commands to the electronic system 900. Input devices that may be used with the input device interface 914 may include, for example, alphanumeric keyboards and pointing devices (also called “cursor control devices”). The output device interface 906 may enable, for example, the display of images generated by electronic system 900. Output devices that may be used with the output device interface 906 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 9, the bus 908 also couples the electronic system 900 to one or more networks and/or to one or more network nodes, such as the electronic device 110 shown in FIG. 1, through the one or more network interface(s) 916. In this manner, the electronic system 900 can be a part of a network of computers (such as a LAN, a wide area network (“WAN”), or an Intranet, or a network of networks, such as the Internet. Any or all components of the electronic system 900 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJ G, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as A SICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “router”, “end device”, “transceiver”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. An apparatus comprising:
processing circuitry configured to perform operations comprising:
initiating a data poll message requesting a data transmission associated with a first wireless communication protocol;
applying one or more coexistence procedures to a resource allocation associated with the first wireless communication protocol based on a coexistence between activity associated with the first wireless communication protocol and activity associated with a second wireless communication protocol different than the first wireless communication protocol on a shared frequency band; and
monitoring for reception of the data transmission associated with the first wireless communication protocol on the shared frequency band based at least in part on the one or more coexistence procedures.

2. The apparatus of claim 1, wherein the operations further comprise:
providing the data poll message for transmission to a parent device configured for managing communication with the apparatus; and
receiving, from the parent device, an acknowledgement message indicating whether data is available for transmission to the apparatus.

3. The apparatus of claim 2, wherein the operations further comprise receiving, from the parent device, the data transmission associated with the first wireless communication protocol based on the acknowledgment message indicating that data is available for transmission to the apparatus.

4. The apparatus of claim 2, wherein applying the one or more coexistence procedures comprises allocating the data poll message to a slot aligned with activity associated with the second wireless communication protocol.

5. The apparatus of claim 2, wherein applying the one or more coexistence procedures comprises adjusting a priority of the data transmission associated with the first wireless communication protocol to be different than a priority of a data transmission associated with the second wireless communication protocol.

6. The apparatus of claim 5, wherein the priority of the data transmission associated with the first wireless communication protocol is adjusted to be greater than the priority of the data transmission associated with the second wireless communication protocol based at least in part on the acknowledgment message indicating that data is available for transmission to the apparatus.

7. The apparatus of claim 5, wherein the priority of the data transmission associated with the first wireless communication protocol is adjusted based at least in part on a level of activity associated with the second wireless communication protocol.

8. The apparatus of claim 2, wherein applying the one or more coexistence procedures comprises monitoring a quality metric of one or more data transmissions associated with the second wireless communication protocol.

9. The apparatus of claim 8, wherein applying the one or more coexistence procedures comprises adjusting a periodicity of the data poll message based at least in part on the quality metric of the one or more data transmissions associated with the second wireless communication protocol.

10. The apparatus of claim 8, wherein applying the one or more coexistence procedures comprises adjusting a priority of the data transmission associated with the first wireless communication protocol to be different than a priority of the one or more data transmissions associated with the second wireless communication protocol based at least in part on the quality metric of the one or more data transmissions associated with the second wireless communication protocol.

11. The apparatus of claim 10, wherein the priority of the data transmission associated with the first wireless communication protocol is adjusted to be greater than the priority of the one or more data transmissions associated with the second wireless communication protocol based at least in part on the quality metric satisfying a quality threshold.

12. The apparatus of claim 10, wherein the priority of the data transmission associated with the first wireless communication protocol is adjusted to be lower than the priority of the one or more data transmissions associated with the second wireless communication protocol based at least in part on the quality metric not satisfying a quality threshold.

13. The apparatus of claim 1, wherein the activity associated with the second wireless communication protocol comprises traffic, and wherein applying the one or more coexistence procedures comprises adjusting a coordinated sample listening (CSL) period based at least in part on the traffic being inactive.

14. A method comprising:
initiating a data poll message requesting a data transmission associated with a first wireless communication protocol;
applying one or more coexistence procedures to a resource allocation associated with the first wireless communication protocol based on a coexistence between activity associated with the first wireless communication protocol and activity associated with a second wireless communication protocol different than the first wireless communication protocol on a shared frequency band; and
monitoring for reception of the data transmission associated with the first wireless communication protocol on the shared frequency band based at least in part on the one or more coexistence procedures.

15. The method of claim 14, further comprising:
initiating a data poll message requesting a data transmission associated with a first wireless communication protocol;
providing the data poll message for transmission to a parent device configured for managing communication with a child device; and
receiving, from the parent device, an acknowledgement message indicating whether data is available for transmission to the child device.

16. The method of claim 15, further comprising receiving, from the parent device, the data transmission associated with the first wireless communication protocol based on the acknowledgment message indicating that data is available for transmission to the child device.

17. The method of claim 15, wherein applying the one or more coexistence procedures comprises allocating the data poll message to a slot aligned with activity associated with the second wireless communication protocol.

18. The method of claim 15, wherein applying the one or more coexistence procedures comprises adjusting a priority of the data transmission associated with the first wireless communication protocol to be different than a priority of a data transmission associated with the second wireless communication protocol.

19. The method of claim 18, wherein the priority of the data transmission associated with the first wireless communication protocol is adjusted to be greater than the priority of the data transmission associated with the second wireless communication protocol based at least in part on the acknowledgment message indicating that data is available for transmission to the child device, and wherein the priority of the data transmission associated with the first wireless communication protocol is adjusted based at least in part on a level of activity associated with the second wireless communication protocol.

20. The method of claim 15, wherein:
applying the one or more coexistence procedures comprises monitoring a quality metric of one or more data transmissions associated with a second wireless communication protocol,
applying the one or more coexistence procedures comprises adjusting one or more of a periodicity of the data poll message or a priority of the data transmission associated with the first wireless communication protocol to be different than a priority of the one or more data transmissions associated with the second wireless communication protocol, based at least in part on the quality metric of the one or more data transmissions associated with the second wireless communication protocol,
the priority of the data transmission associated with the first wireless communication protocol is adjusted to be greater than the priority of the one or more data transmissions associated with the second wireless communication protocol based at least in part on the quality metric satisfying the quality threshold, and
the priority of the data transmission associated with the first wireless communication protocol is adjusted to be lower than the priority of the one or more data transmissions associated with the second wireless communication protocol based at least in part on the quality metric not satisfying a quality threshold.

21. An apparatus comprising:
processing circuitry configured to perform operations comprising:
initiating a data poll message requesting a data transmission associated with a first wireless communication protocol;
applying one or more coexistence procedures to a resource allocation associated with the first wireless communication protocol based on a coexistence between activity associated with the first wireless communication protocol and activity associated with a second wireless communication protocol different than the first wireless communication protocol on a shared frequency band; and
monitoring for reception of the data transmission associated with the first wireless communication protocol on the shared frequency band based at least in part on the one or more coexistence procedures.
